(19) United States
(12) Patent Application Publication
(10) Pub. No.: US 2026/0289824 A1
(43) Pub. Date: Sep. 24, 2026

(54) GENERATIVE-BASED PREDICTIVE CODING FOR LIDAR POINT CLOUD COMPRESSION

(71) Applicant: InterDigital VC Holdings, Inc., Wilmington, DE (US)

(72) Inventors: Jiahao Pang, Plainsboro, NJ (US); Muhammad Asad Lodhi, Highland Park, NJ (US); Junghyun Ahn, New York, NY (US); Dong Tian, Boxborough, MA (US)

(21) Appl. No.: 19/476,128

(22) PCT Filed: Apr. 17, 2024
(86) PCT No.: PCT/US2024/025037

§ 371 Date: Oct. 16, 2025

Related U.S. Application Data
(60) Provisional application No. 63/526,130, filed on Jul. 11, 2023.

(51) Int. Cl. G06T 9/00

(52) U.S. Cl. CPC G06T 9/002

(57) ABSTRACT

Some embodiments of a method (implemented, e.g., by a decoder) may include: obtaining a reference point cloud frame; obtaining a transformation feature map, wherein the transformation feature map describes motion between the reference point cloud frame and a current point cloud frame; determining a predicted point cloud frame in a point-based representation based on the reference point cloud frame and the transformation feature map; determining a predicted feature map based on the predicted point cloud frame, using a point-based encoder neural network; obtaining a current feature map, wherein the current feature map represents the current point cloud frame; and reconstructing the current point cloud frame using a point-based decoder neural network, based on the current feature map, using the predicted feature map as a condition. Some embodiments may encode the current feature frame into a bitstream instead of reconstructing the current point cloud frame.

### CROSS-REFERENCE TO RELATED APPLICATIONS

The present application claims benefit under 35 U.S.C. § 119 (e) from U.S. Provisional Patent Application Ser. No. 63/526,130, entitled “GENERATIVE-BASED PREDICTIVE CODING FOR LIDAR POINT CLOUD COMPRESSION” and filed Jul. 11, 2023, which is hereby incorporated by reference in its entirety.

### INCORPORATION BY REFERENCE

The present application incorporates by reference in its entirety the following applications: U.S. Provisional Patent Application Ser. No. 63/252,482, entitled “Method and Apparatus for Point Cloud Compression Using Hybrid Deep Entropy Coding” and filed Oct. 5, 2021 (“482 application”); U.S. Provisional Patent Application Ser. No. 63/291,015, entitled “Hybrid Framework for Point Cloud Compression” and filed Dec. 17, 2021 (“015 application”); U.S. Provisional Patent Application Ser. No. 63/297,869, entitled “A Scalable Framework for Point Cloud Compression” and filed Jan. 10, 2022 (“869 application”); U.S. Provisional Patent Application Ser. No. 63/297,894, entitled “Coordinate Refinement and Upsampling from Quantized Point Cloud Reconstruction” and filed Jan. 10, 2022 (“894 application”); U.S. Provisional Patent Application Ser. No. 63/388,087, entitled “A Scalable Framework for Point Cloud Compression” and filed Jul. 11, 2022 (“087 application”); U.S. Provisional Patent Application Ser. No. 63/388,600, entitled “Deep Distribution-Aware Point Feature Extractor for AI-Based Point Cloud Compression” and filed Jul. 12, 2022 (“600 application”); U.S. Provisional Patent Application Ser. No. 63/417,284, entitled “Context-Aware Voxel-Based Upsampling for Point Cloud Processing” and filed Oct. 18, 2022 (“284 application”); and U.S. Provisional Patent Application Ser. No. 63/438,212, entitled “Context-Aware Voxel-Based Upsampling for Point Cloud Processing” and filed Jan. 10, 2023 (“212 application”); U.S. Provisional Patent Application Ser. No. 63/460,798, entitled “Generative-Based Predictive Coding for Point Cloud Compression” and filed Apr. 20, 2023 (“798 application”).

### BACKGROUND

Point cloud is a data format used across several business domains from autonomous driving, robotics, AR/VR, civil engineering, computer graphics, to the animation/movie industry. 3D LiDAR sensors have been deployed in self-driving cars, and affordable LiDAR sensors are released from, e.g., Velodyne Velabit, Apple iPad Pro 2020, and Intel RealSense LiDAR camera L515. With advances in sensing technologies, 3D point cloud data becomes more practical than ever and is expected to be an ultimate enabler in the applications mentioned.

Point cloud data is also believed to consume a large portion of network traffic, e.g., immersive communications (VR/AR) and cars connected over a 5G network. Efficient representation formats may be used with point clouds and communication. In particular, raw point cloud data is organized and processed for the purposes of world modeling & sensing. Compression of raw point clouds may be used with storage and transmission of data in related scenarios.

Furthermore, point clouds may represent a sequential scan of the same scene, which may contain multiple moving objects. Such point clouds are called dynamic point clouds compared to static point clouds captured from a static scene or static objects. Dynamic point clouds are typically organized into frames, with different frames being captured at different times. Dynamic point clouds may use processing and compression in real-time and/or to have a low amount of delay.

### SUMMARY

A first example method in accordance with some embodiments may include: obtaining a reference point cloud frame; obtaining a transformation feature map, wherein the transformation feature map describes motion between the reference point cloud frame and a current point cloud frame; determining a predicted point cloud frame in a point-based representation based on the reference point cloud frame and the transformation feature map; determining a predicted feature map based on the predicted point cloud frame, using a first point-based neural network; obtaining a current feature map, wherein the current feature map represents the current point cloud frame; and reconstructing the current point cloud frame using a second point-based neural network, based on the current feature map, using the predicted feature map as a condition.

For some embodiments of the first example method, the first point-based neural network includes a point-based encoder neural network, and the second point-based neural network includes a point-based decoder neural network.

For some embodiments of the first example method, the reference point cloud frame was decoded from an earlier point cloud frame prior to the current point cloud frame.

For some embodiments of the first example method, determining the predicted point cloud frame includes: decoding a motion field based on the transformation feature map; and generating the predicted point cloud frame based on the reference point cloud frame and the decoded motion field.

For some embodiments of the first example method, decoding the motion field includes: performing feature aggregations iteratively on the transformation feature map to derive a feature aggregation iterative output; and performing a convolution on the feature aggregation iterative output to generate the motion field.

Some embodiments of the first example method may further include performing at least one upsampling on the feature aggregation output prior to performing the convolution.

For some embodiments of the first example method, generating the predicted point cloud frame includes: shifting occupied blocks in the reference point cloud frame based on the motion field; searching the reference point cloud frame to obtain nearest neighbors, based on the shifted occupied block coordinates; and creating the predicted point cloud using the obtained nearest neighbors.

For some embodiments of the first example method, reconstructing the current point cloud frame includes: performing a conditional decode to generate the current feature map; and performing a point cloud decode using the current feature map to generate the current point cloud frame.

For some embodiments of the first example method, performing the conditional decode includes: performing a concatenation on a conditional feature map based on the predicted feature map; and performing feature aggregations iteratively to generate the current feature map.

For some embodiments of the first example method, the concatenation is further based on an additional condition.

For some embodiments of the first example method, the additional condition includes a hidden memory decoder output.

Some embodiments of the first example method may further include generating the hidden memory decoder output based on the transformation feature map.

Some embodiments of the first example method may further include upsampling the transformation feature map.

For some embodiments of the first example method, reconstructing the current point cloud frame uses a constant point cloud as a condition instead of the predicted feature map.

A first example apparatus in accordance with some embodiments may include: a processor; and a non-transitory computer-readable medium storing instructions operative, when executed by the processor, to cause the apparatus to: obtain a reference point cloud frame; obtain a transformation feature map, wherein the transformation feature map describes motion between the reference point cloud frame and a current point cloud frame; determine a predicted point cloud frame in a point-based representation based on the reference point cloud frame and the transformation feature map; determine a predicted feature map based on the predicted point cloud frame, using a first point-based neural network; obtain a current feature map, wherein the current feature map represents the current point cloud frame; and reconstruct the current point cloud frame using a second point-based neural network, based on the current feature map, using the predicted feature map as a condition.

For some embodiments of the first example apparatus, the first point-based neural network includes a point-based encoder neural network, and the second point-based neural network includes a point-based decoder neural network.

A second method in accordance with some embodiments may include: obtaining a reference point cloud frame; obtaining a first transformation feature map, wherein the first transformation feature map describes motion between the reference point cloud frame and a current point cloud frame; encoding the first transformation feature map; reconstructing a second transformation feature map from the first transformation feature map; determining a predicted point cloud frame under the point-based representation, based on the reference point cloud frame and the second transformation feature map; determining a predicted feature map based on the predicted point cloud frame, using a first point-based neural network; determining a current feature map, using a second point-based neural network, wherein the current feature map represents the current point cloud frame; and encoding the current feature map into a bitstream using the predicted feature map as a condition.

For some embodiments of the second example method, the first point-based neural network includes a first point-based encoder neural network, and wherein the second point-based neural network includes a second point-based encoder neural network.

Some embodiments of the second example method may further include sending the first bitstream to a decoder.

For some embodiments of the second example method, the reference point cloud frame was encoded previously.

For some embodiments of the second example method, determining the predicted point cloud frame includes: decoding a motion field based on the second transformation feature map; and generating the predicted point cloud frame based on the reference point cloud frame and the decoded motion field.

For some embodiments of the second example method, decoding the motion field includes: performing feature aggregations iteratively on the second transformation feature map to derive a feature aggregation iterative output; and performing a convolution on the feature aggregation iterative output to generate the motion field.

Some embodiments of the second example method may further include performing at least one upsampling on the feature aggregation output prior to performing the convolution.

For some embodiments of the second example method, generating the predicted point cloud frame includes: shifting occupied blocks in the reference point cloud frame based on the motion field; searching the reference point cloud frame to obtain nearest neighbors, based on the shifted occupied block coordinates; and creating the predicted point cloud using the obtained nearest neighbors.

For some embodiments of the second example method, encoding the current point cloud frame includes: performing a point cloud encode using the current point cloud frame to generate the current feature map; performing a conditional encode to generate a conditional feature map; and generating the second bitstream based on the conditional feature map.

For some embodiments of the second example method, performing the conditional encode includes: performing a concatenation on the current feature map based on the predicted feature map; and performing feature aggregations iteratively to generate a conditional feature map.

For some embodiments of the second example method, the concatenation is further based on an additional condition.

For some embodiments of the second example method, the additional condition is a hidden memory decoder output.

Some embodiments of the second example method may further include generating the hidden memory decoder output based on the second transformation feature map.

Some embodiments of the second example method may further include downsampling the second transformation feature map.

For some embodiments of the second example method, encoding the current feature map into the second bitstream uses a constant point cloud as a condition instead of the predicted feature map.

For some embodiments of the second example method, obtaining the first transformation feature map includes extracting one or more motion differences between the reference point cloud frame and the current point cloud frame to generate the first transformation feature map.

For some embodiments of the second example method, obtaining the first transformation feature map includes generating the first transformation feature map using the reference point cloud frame and the current point cloud frame.

For some embodiments of the second example method, obtaining the transformation feature map includes using an augmented version of the reference point cloud frame and an augmented version of the current point cloud frame.

A second apparatus in accordance with some embodiments may include: a processor; and a non-transitory computer-readable medium storing instructions operative, when executed by the processor, to cause the apparatus to: obtain a reference point cloud frame; obtain a first transformation feature map, wherein the first transformation feature map describes motion between the reference point cloud frame and a current point cloud frame; encode the first transformation feature map; reconstruct a second transformation feature map from the first transformation feature map; determine a predicted point cloud frame under the point-based representation, based on the reference point cloud frame and the second transformation feature map; determine a predicted feature map based on the predicted point cloud frame, using a first point-based neural network; determine a current feature map, using a second point-based neural network, wherein the current feature map represents the current point cloud frame; and encode the current feature map into a bitstream using the predicted feature map as a condition.

For some embodiments of the second example apparatus, the first point-based neural network includes a first point-based encoder neural network, and wherein the second point-based neural network includes a second point-based encoder neural network.

A third apparatus in accordance with some embodiments may include a processor configured to perform any of the methods listed above.

For some embodiments of the third example apparatus, the apparatus includes a decoding device.

A fourth apparatus in accordance with some embodiments may include: a processor configured to perform any of the methods listed above.

For some embodiments of the fourth example apparatus, the apparatus includes an encoding device.

For some embodiments of the second example method, generating the first transformation feature map further uses one or more point cloud attributes.

For some embodiments of the second example method, the point cloud attributes include color or reflectance attributes associated with at least one point of the point cloud.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 1C is a system diagram illustrating an example set of interfaces for a system according to some embodiments.

FIG. 2A is a schematic illustration showing an example point-based representation of a point cloud.

FIG. 2B is a schematic illustration showing an example voxel-based representation of a point cloud.

FIG. 2C is a schematic illustration showing an example sparse voxel-based representation of a point cloud.

FIG. 3 is a block diagram illustrating an example block partition coding branch of a dynamic point cloud compression (DPCC).

FIG. 4 is a block diagram illustrating an example predictor generation branch of a deep-dynamic point cloud compression (D-DPCC).

FIG. 5 is a block diagram illustrating an example feature coding branch of a D-DPCC.

FIG. 6 is a block diagram illustrating an example predictor generation branch.

FIG. 7 is a block diagram illustrating an example predictor generation branch according to some embodiments.

FIG. 8 is a block diagram illustrating an example feature coding branch according to some embodiments.

FIG. 9 is a block diagram illustrating an example transformation feature extractor according to some embodiments.

FIG. 10 is a block diagram illustrating an example predicted point cloud generator according to some embodiments.

FIG. 11 is a block diagram illustrating an example motion decoder according to some embodiments.

FIGS. 12A-12E are process diagrams illustrating an example predicted point cloud synthesis process according to some embodiments.

FIG. 13 is a process diagram illustrating an example point cloud encoder according to some embodiments.

FIG. 14 is a process diagram illustrating an example point cloud decoder according to some embodiments.

FIG. 15A is a block diagram illustrating an example conditional encoder according to some embodiments.

FIG. 15B is a block diagram illustrating an example conditional decoder according to some embodiments.

FIG. 16 is a block diagram illustrating an example predictor generation branch with hidden memory according to some embodiments.

FIG. 17 is a block diagram illustrating an example feature coding branch utilizing hidden memory according to some embodiments.

FIGS. 18A and 18B are block diagrams illustrating an example predictor generation branch with a transformation feature downsampling according to some embodiments.

FIG. 19 is a block diagram illustrating an example feature coding branch in intra mode according to some embodiments.

FIG. 20 is a block diagram illustrating an example transformation feature extractor using augmented point clouds according to some embodiments.

FIG. 21 is a process diagram illustrating an example point cloud encoder according to some embodiments.

FIG. 22 is a flowchart illustrating an example point cloud decoder process according to some embodiments.

FIG. 23 is a flowchart illustrating an example point cloud encoder process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

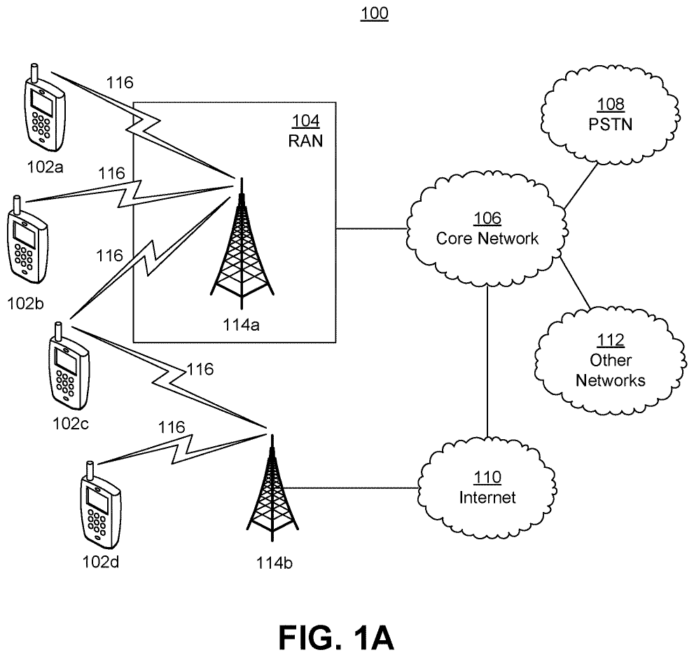

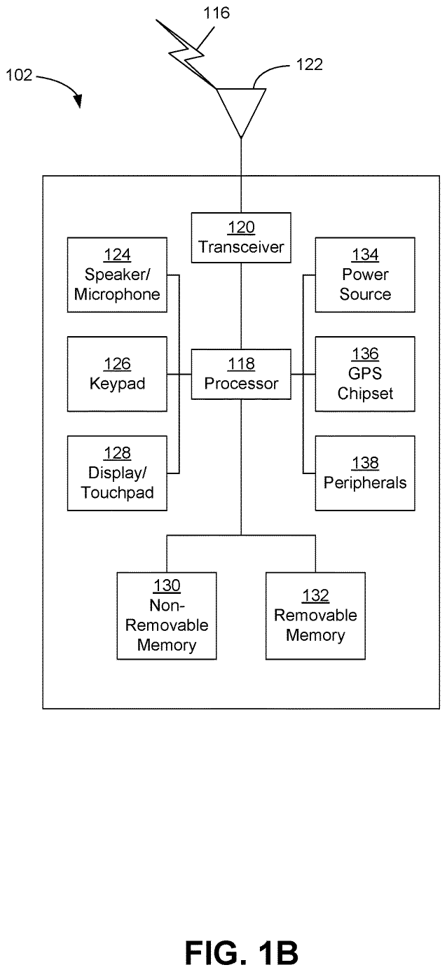

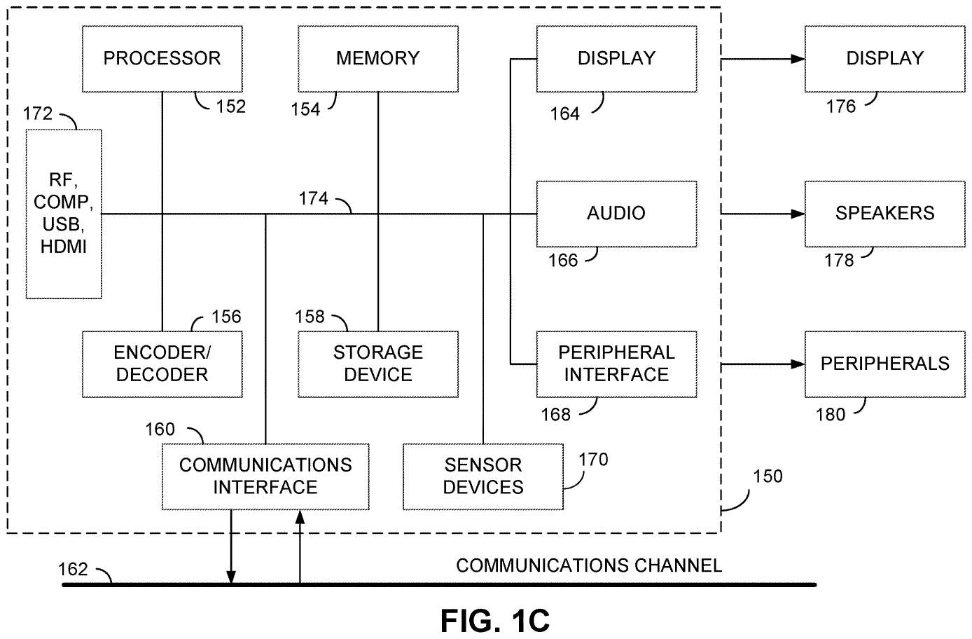

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1C is a system diagram illustrating an example set of interfaces for a system according to some embodiments. An extended reality display device, together with its control electronics, may be implemented. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (I2C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV·Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Point Cloud Processing and Compression

For some embodiments, this application addresses challenges of dynamic point cloud compression (D-PCC) for sparse LiDAR point clouds. For some embodiments, to compress a current point cloud frame given a reference point cloud frame, the present application, unlike some existing D-PCC architectures, explicitly generates a predicted point cloud frame on both the encoder and the decoder.

To further enhance compression performance, the present application, for some embodiments, applies a conditional coding paradigm to compress the current point cloud frame condition on the predicted point cloud frame. For some embodiments, to tailor for the sparse nature of LiDAR point clouds, point-based neural networks may be specifically utilized for encoding and decoding LiDAR point clouds.

This application discusses, in accordance with some example embodiments, point cloud processing and compression, which includes processing, compression, representation, analysis, and understanding of point cloud signals. Furthermore, this application discusses, in accordance with some example embodiments, an adaptive, point-based representation point cloud upsampling method based on deep neural networks, including some embodiments applied to point cloud processing and compression. This application also discusses, in accordance with some example embodiments, performing upsampling in the point-based representation point cloud domain.

Point cloud data may consume a large portion of network traffic, e.g., among connected cars over a 5G network and in immersive (e.g., AR/VR/MR) communications. Efficient representation formats may be used for point clouds and communication. In particular, raw point cloud data may be organized and processed for modeling and sensing, such as the world, an environment, or a scene. Compression of raw point clouds may be used with storage and transmission of the data.

Furthermore, point clouds may represent sequential scans of the same scene, which may contain multiple moving objects. Dynamic point clouds capture moving objects, while static point clouds capture a static scene and/or static objects. Dynamic point clouds may be typically organized into frames, with different frames being captured at different times. The processing and compression of dynamic point clouds may be performed in real-time or with a low amount of delay.

Point clouds may be used, e.g., in the automotive industry with autonomous vehicles. Autonomous cars “probe” their environment to make good driving decisions based on the reality of their immediate surroundings. Sensors such as LiDARs produce (dynamic) point clouds that are used by a perception engine. These point clouds typically are not intended to be viewed by human eyes, and these point clouds may or may not be colored and are typically sparse and dynamic with a high frequency of capture. Such point clouds may have other attributes like the reflectance ratio provided by the LiDAR because this attribute is indicative of the material of the sensed object and may help in making a decision.

Virtual Reality (VR) and immersive worlds have become a hot topic and are foreseen by many as the future of 2D flat video. The viewer may be immersed in an all-around environment, as opposed to standard TV where the viewer only looks at a virtual world in front of the viewer. There are several gradations in the immersivity depending on the freedom of the viewer in the environment. Point cloud formats may be used to distribute VR worlds and environment data. Such point clouds may be static or dynamic and are typically average size, such as less than several millions of points at a time.

Point clouds also may be used for various other purposes, such as scanning of cultural heritage objects and/or buildings in which objects such as statues or buildings are scanned in 3D. The spatial configuration data of the object may be shared without sending or visiting the actual object or building. Also, this data may be used to preserve knowledge of the object in case the object or building is destroyed, such as a temple by an earthquake. Such point clouds, typically, are static, colored, and huge in size.

Another use case for point clouds is in topography and cartography. In using 3D representations within such fields, maps may not be limited to a plane and may include the relief. Google Maps, for example, is understood to use meshes instead of point clouds for their 3D maps. Nevertheless, point clouds may be a suitable data format for 3D maps, and such cartography point clouds, typically, are also static, colored, and huge in size.

World modeling and sensing via point clouds may allow machines to record and use spatial configuration data about the 3D world around them, which may be used in the applications discussed above.

3D point cloud data include essentially discrete samples of surfaces of objects or scenes. To fully represent the real world with point samples, a huge number of points may be used. For instance, a typical VR immersive scene includes millions of points, while point clouds typically may include hundreds of millions of points. Therefore, the processing of such large-scale point clouds is computationally expensive, especially for consumer devices, e.g., smartphones, tablets, and automotive navigation systems, which may have limited computational power.

To store and process the input point cloud with affordable computational cost, the input point cloud may be down-sampled, in which the down-sampled point cloud summarizes the geometry of the input point cloud while having much fewer points. The down-sampled point cloud is inputted into a subsequent machine task for further processing. The down-sampled point cloud may be processed by gradually upsampling the point cloud. In particular, for some embodiments, a learning-based autoencoder architecture may use downsampling for feature extraction and upsampling for reconstruction. Such upsampling, for example, may be used with point cloud compression (e.g., on the decoder) and with point cloud super-resolution. Among other things, this application discusses examples of adaptive point cloud upsampling methods, in accordance with some embodiments.

This application relates to point cloud compression and processing. This field aims to develop tools for compression, analysis, interpolation, representation, and understanding of point cloud signals.

For some embodiments, efficient storage methodologies may be used with processing or inference of point clouds. To store and process the input point cloud with affordable computational cost, some embodiments down-sample first, in which the down-sampled point cloud “summarizes” the geometry of the input point cloud while having much fewer points. The down-sampled point cloud is inputted into a machine task for further consumption. For some embodiments, further reduction in storage space may be achieved by converting the raw point cloud data (original or down-sampled) into a bitstream through entropy coding techniques for lossless compression.

In addition to lossless coding, many scenarios for lossy coding seek a significantly improved compression ratio while maintaining the induced distortion below certain quality levels. To achieve a less lossy coding, an efficient point feature extractor improves the accuracy of reconstruction within a given resource budget.

### Learning-Based Dynamic Point Cloud Compression (DPCC)

Rather than compressing an isolated point cloud, a dynamic point cloud sequence compresses many frames. Inter-coding is relatively new in the point cloud compression domain, especially for the learning-based PCC. In line with the evolution of deep-learning-based point cloud processing techniques, this application discusses, in accordance with some example embodiments, learning-based LiDAR point cloud sequences.

Point cloud compression is used in many practical applications, such as autonomous driving and AR/VR. This application concerns, e.g., in accordance with some example embodiments, lossy compression of dynamic point cloud sequences based on sparse tensor processing and deep learning.

Learning-based dynamic point cloud compression (D-PCC) has been gaining increased interest recently.

### Point-Based Representation

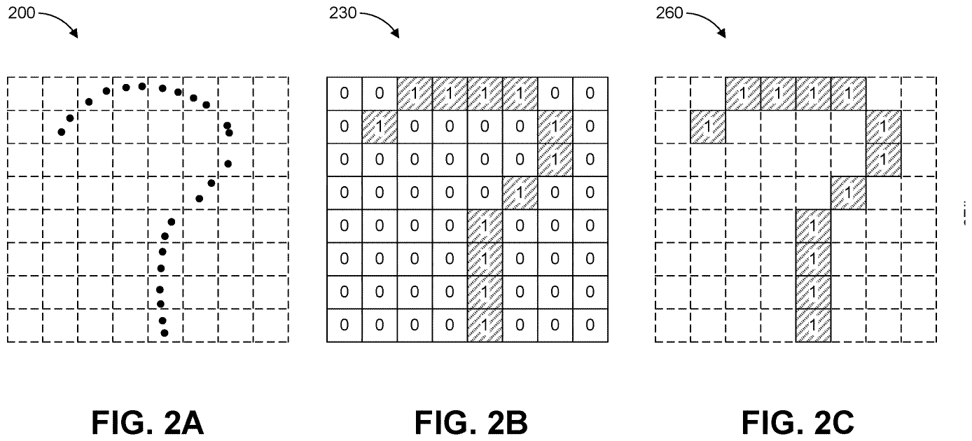

FIG. 2A is a schematic illustration showing an example point-based representation of a point cloud. For some embodiments, a point cloud is a set of 3D coordinates that samples the surface of objects or scenes. In this native representation 200, each point is directly specified by its x, y, and z coordinates in the 3D space. However, the points in a point cloud may be unorganized and sparsely distributed in the 3D space, making direct processing of the point coordinates challenging for some applications. FIG. 2A provides an example of point-based representation. For simplicity, FIGS. 2A to 2C showcase corresponding point cloud representations in 2D space.

Due to development of deep learning, point cloud processing and compression have also been studied with native point-based representations. A representative work in this thread is PointNet, which is a point-based processing architecture based on multi-layer perceptrons (MLP) and global max pooling operators for feature extraction. Subsequent works, such as PointNet++, DGCNN, and KP-Conv, extend PointNet to more complex point-based operations that account for neighboring information. These point-based architectures may be utilized for point cloud compression and processing.

Point-based neural networks may be more flexible and more suitable for processing point clouds that are sparsely distributed in 3D space. For some embodiments, a point-based neural network may be used to process dynamic LiDAR point clouds, which are typically very sparse.

### Voxel-Based Representation

FIG. 2B is a schematic illustration showing an example voxel-based representation of a point cloud. Recent D-PCC approaches utilize a sparse voxel (or 3D sparse tensor) format and 3D sparse convolution to achieve efficient processing. In a voxel-based representation 230, 3D point coordinates are uniformly quantized by a quantization step. Each point corresponds to an occupied voxel with a size equal to the quantization step. In this scenario, an occupied voxel has a value of 1, and an empty voxel has a value of 0. See FIG. 2B. Such a voxel representation may not be an efficient memory usage since most voxels are empty (0). To resolve this issue, sparse voxel representation is introduced where the occupied voxels are arranged as a sparse tensor for efficient storage and processing.

FIG. 2C is a schematic illustration showing an example sparse voxel-based representation of a point cloud. In a 3D sparse tensor 260, only the coordinates of the occupied voxel and the associated features will be kept in memory. An example of a sparse voxel representation is depicted in FIG. 2C, in which an empty voxel (with dotted lines) does not consume memory/storage. Under a sparse tensor representation, the feature map of an input point cloud has only one (1) channel, in which every occupied voxel has an associated value of 1, as shown in FIG. 2C.

Hence, as shown in FIG. 2C, for some embodiments, only occupied voxels are coded (in which such voxels are coded as a “1”), not an occupancy status for every voxel. Also, for some embodiments, FIG. 2C may be viewed as an example of a feature map. A feature map may be treated as a common term used in image processing in which a feature vector may be delineated for each pixel or 3D point. The dimension, which may be termed channel size in some contexts, of such a feature vector may grow or shrink based on the definition of a neural network layer. In learning-based pipelines, features typically refer to the vectors outputted by neural network layers. When each output point (sample) in a point cloud is associated with a feature, the set of all features may be called a feature map. Additionally, a neural network layer may take a feature map outputted from a previous neural network layer as an input into the neural network layer. An initial input point cloud to a pipeline may be viewed as a feature map. A feature or a feature map typically indicates certain high-level information in a latent space, depending on the design of the neural network pipeline.

Point clouds that are represented as 3D voxels may be processed/digested with 3D convolutional neural networks (CNN). This idea is inspired by the success of applying 2D CNNs to 2D images. With a typical 3D convolution, a 3D kernel is overlaid on every location specified by a stride step, no matter whether the voxels are occupied or empty. To avoid excessive computation and memory consumption incurred by empty voxels, sparse 3D convolutional layers are introduced when the point cloud voxels are represented by a sparse tensor.

### D-DPCC

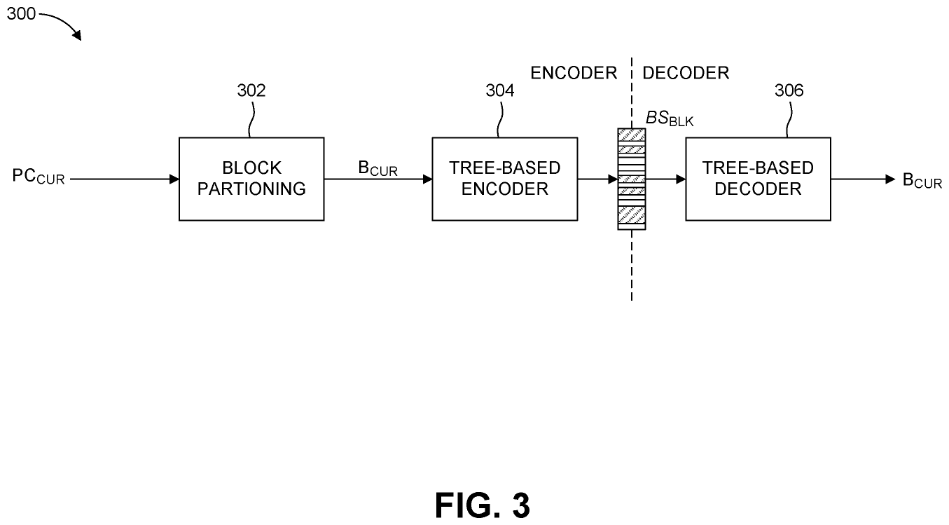

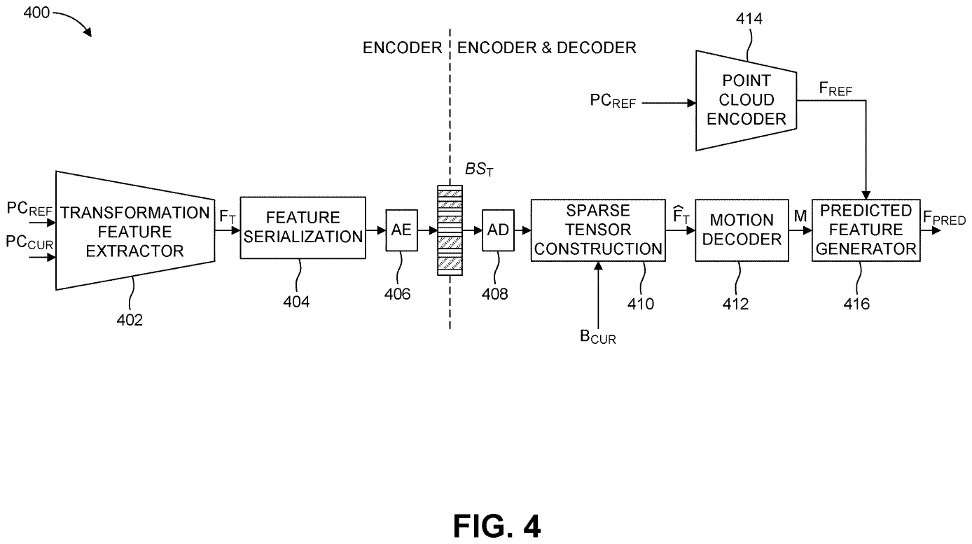

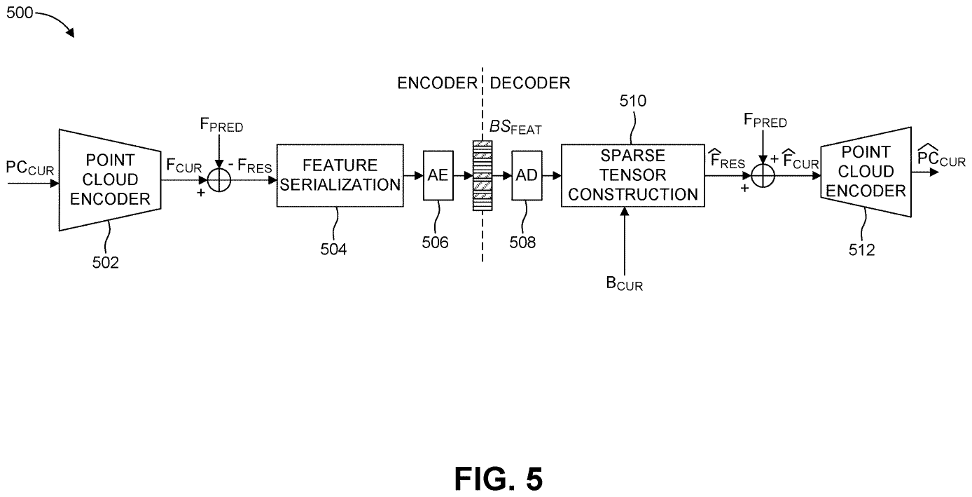

Journal article Fan, Tingyu, et al., D-DPCC: Deep Dynamic Point Cloud Compression via 3D Motion Prediction, PROCEEDINGS OF THE 31ST INTERNATIONAL JOINT CONFERENCE ON ARTIFICIAL INTELLIGENCE (IJCAI 2022) 898-904 (2022) (“Fan”) discusses a D-DPCC framework. The architecture of D-DPCC includes three parts: (i) a block partition coding branch, which is shown in FIG. 3; (ii) a predictor generation branch, which is shown in FIG. 4; and (iii) a residual coding branch, which is shown in FIG. 5.

### Block Partition Coding

FIG. 3 is a block diagram illustrating an example block partition coding branch of a dynamic point cloud compression (DPCC). A block partition coding branch 300 compresses the block partitioning scheme of the current point cloud frame PC_{cur}. To encode an n-bit current point cloud frame, PC_{cur}, in a 2ⁿ×2ⁿ×2ⁿ3D space, the block partitioning functionality 302 divides PC_{cur} into blocks of size 2^{m}×2^{m}×2^{m}, in which (m<n), and outputs 3D coordinates of the occupied (non-empty) blocks, B_{cur}. The occupied block coordinates represent a coarse geometry of the current point cloud frame. The occupied block coordinates signal the block positions with 3D points in those blocks, such that subsequent encoding/decoding only happens within occupied blocks.

For some embodiments, B_{cur} is a coded representation of the block partitioning. For some embodiments, B_{cur} may include only the 3D coordinates of the occupied (non-empty) blocks. Hence, B_{cur} indicates which blocks of PC_{cur} actually have points in them.

If there are b occupied blocks, Bour is a b×3 list, which is a list or set of b 3D coordinates. B_{cur} is passed to a tree-based encoder 304 for encoding losslessly, leading to the block partition bit stream BS_{blk}. On the decoder side, a tree-based decoder 306 decodes the block partition bitstream BS_{blk} and gets back the occupied block positions B_{cur} losslessly.

### Predictor Generation

FIG. 4 is a block diagram illustrating an example predictor generation branch of a deep-dynamic point cloud compression (D-DPCC). Similar to traditional 2D video compression, D-DPCC, according to Fan, also performs motion estimation between the current point cloud frame and the reference point cloud frame and encodes the motion information for predictor generation on both the encoder and the decoder. This functionality may be accomplished by the predictor generation branch 400, an embodiment of which is shown in FIG. 4. Firstly, the current point cloud frame PC_{cur} and the reference point cloud frame PC_{ref} are inputted into a transformation feature extractor block 402, which aggregates and down-samples for 2™ times and outputs a 3D sparse tensor, F_{T}. The 3D sparse tensor, F_{T}, is an abstract feature map containing the motion/transformation information between PC_{cur} and PC_{ref}. By this design, in accordance with some embodiments, the coordinates of the sparse tensor F_{T}, which may be called the transformation feature map, are aligned with B_{cur}, which may occur in a feature serialization block 404. F_{T} is quantized and entropy encoded by the arithmetic encoder (AE) 406, which outputs the encoded transformation bitstream, BS_{T}. AE quantizes and entropy encodes the 3D sparse tensor, F_{T}.

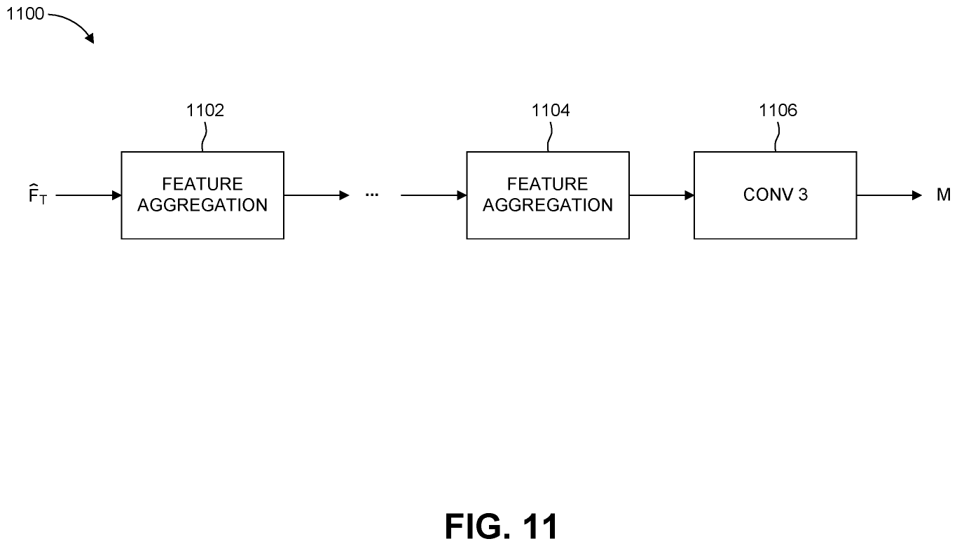

As a special feature map, the transformation feature map depicts the motion (or transformation) relationship between the current frame and the reference frame. This relationship is achieved by generating/determining an intermediate output, which is a motion vector, M. This relationship between the current frame and the reference frame is also achieved by the architecture and how the feature map is further used. For FIG. 4, the feature map is processed to become motion. Through training, this feature map has its special meaning. The transformation map is used to generate and/or is processed to become a motion vector. See the example in FIG. 11. As such, this feature map is called a “transformation feature map.”

On the right side of FIG. 4, the arithmetic decoder (AD) 408 decodes the bitstream, BS_{T}. The sparse tensor construction block 410 incorporates the block coordinates B_{cur} into the decoded bitstream and outputs a reconstructed transformation feature map, denoted as F_{T}. The reconstructed transformation feature map may be considered a quantized version of F_{T} for some embodiments. Fr may be quantized based on the occupied positions from B_{cur}. Fr is then inputted into the motion decoder 412, which outputs block-wise motion vectors (which may be called a motion field for some embodiments) M for the blocks in B_{cur}. A predicted feature generator block 416 computes a predicted feature map of the current frame, denoted F_{pred}. For some embodiments, generating a predicted feature map may be accomplished by computing a feature map of the reference point cloud frame F_{ref} with a point cloud encoder 414, followed by linearly warping F_{ref} according to the estimated motion field M. The predicted feature map F_{pred} serves as a predictor to facilitate coding of the current point cloud frame, PC_{cur}. The predicted feature map is generated on both the encoder and decoder sides, which are split by a dashed line in FIG. 4.

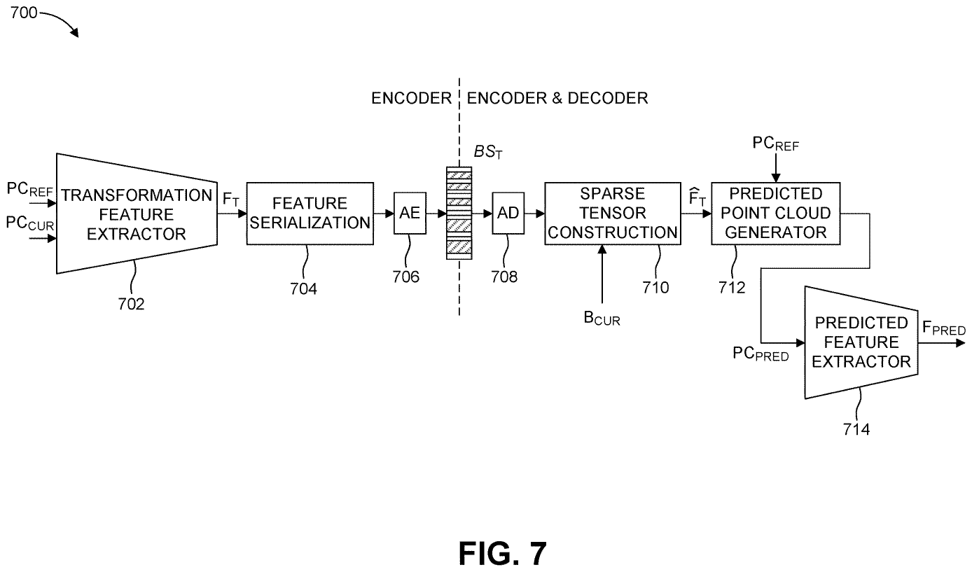

The motion decoder produces block-wise motion vectors, M, for the occupied blocks, which are indicated by B_{cur}. F_{ref} is the feature map of the reference point cloud, PC_{ref}. The predicted feature generator warps the feature map, F_{ref}, using motion vectors, M. The predicted feature generator produces the predicted feature map for the current frame, F_{pred}. For some embodiments, F_{pred} is determined as shown in FIGS. 7, 10, and 12. B_{cur} may be generated as shown in FIG. 3.

### Feature Coding

FIG. 5 is a block diagram illustrating an example feature coding branch of a D-DPCC. Similar to traditional 2D video compression, a D-DPCC framework, according to Fan, applies the residual coding paradigm to encode the current point cloud frame PC_{cur}, as shown in the feature coding branch 500 of FIG. 5. The current point cloud frame, PC_{cur}, is inputted into a point cloud encoder 502 to extract a feature map F_{cur}, which is a high-level/abstract representation of PC_{cur}. Instead of encoding PC_{cur} directly, a D-DPCC framework aims to encode its feature map F_{cur}. The point cloud encoder 502 in FIG. 5 may be the same point cloud encoder 414 used in the predictor coding branch (FIG. 4). Therefore, F_{cur} and F_{pred} are in the same feature space. Therefore, a residual feature may be computed (or determined) according to Eq. 1:

$${F}_{res} = {F}_{cur} - {F}_{pred} \qquad Eq . 1$$

The residual feature is entropy encoded via a feature serialization 504 followed by an arithmetic encoder (AE) 506 on the encoder side, leading to the feature bitstream, BS_{feat}. On the decoder side, the reconstructed residual feature \hat{F}ᵣₑₛ is obtained, via arithmetic decoding (AD) 508 and sparse tensor construction 510. The residual feature, \hat{F}ᵣₑₛ, may resemble a quantized version of Fᵣₑₛ. By adding back the predicted feature map, F_{pred}, the reconstructed feature map of the current point cloud is obtained, which is denoted as \hat{F}_{cur} in Eq. 2:

$${\hat{F}}_{cur} = {\hat{F}}_{res} + {F}_{pred} \qquad Eq . 2$$

The reconstructed feature map is inputted into a point cloud decoder 512 to reconstruct the decoded point cloud, [symbol] .

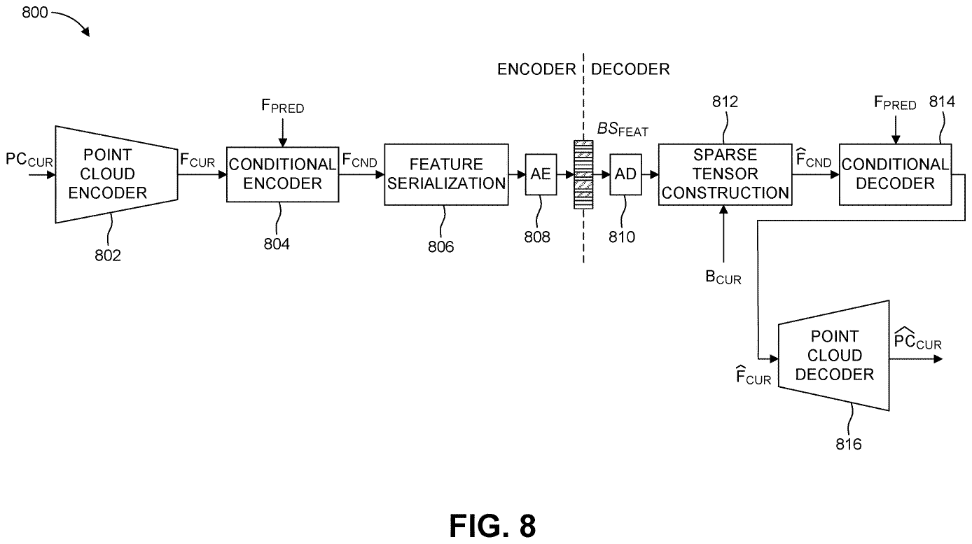

F_{pred} is the feature map of a reference frame warped by motion vectors that represent motion between the current frame and the reference frame. The residual feature vector, Fᵣₑₛ, is encoded using AE and decoded using AD. \hat{F}ᵣₑₛ is the decoded and reconstructed version of the residual feature vector, Fᵣₑₛ. \hat{F}_{cur} is the reconstructed version of the “feature map” F_{cur}, which carries the features of the current point cloud. For some embodiments, instead of using a residual feature map, PC_{cur} is encoded directly and used as shown in FIGS. 8, 15A, and 16.

### Alternative Predictor Generation

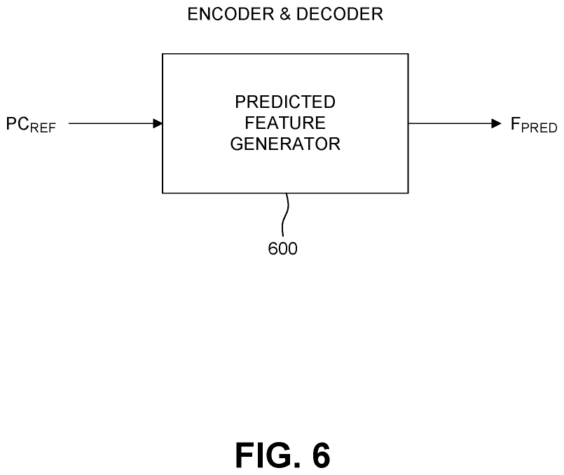

FIG. 6 is a block diagram illustrating an example predictor generation branch. In the journal article, Akhtar, Anique, et al., Inter-Frame Compression for Dynamic Point Cloud Geometry Coding, ARXIV PREPRINT ARXIV: 2207.12554 (2022) (“Akhtar”), another D-PCC framework is shown. Aktar and Fan have the same (or similar) block partition coding branch and feature code branch, but Aktar has a different predictor coding branch, which is shown in FIG. 6.

Instead of performing motion analysis between the current point cloud frame, PC_{cur}, and the reference point cloud frame, PC_{ref}, Akhtar proposed directly estimating the predicted feature, F_{pred}, of the current frame from the reference point cloud frame, PC_{ref}, based on its proposed predicted feature generator 600. Compared to the D-DPCC of Fan, the design choice of Akhtar is simpler because there is no explicit motion analysis. However, the compression performance may be compromised since the compression performance is unreliable to estimate/predict the feature of the current frame simply based on the reference frame.

The '798 application is referenced in places throughout this application, but it should be understood that the '798 application discloses, envisions, and encompasses many diverse embodiments, implementations, and/or examples. For explanatory purposes, in some cases reference may be made to what the '798 application discloses or discusses. It should be understood that such references are to one or more example embodiments, implementations, or examples of the '798 application solely for explanatory purposes in this application, and are not intended to in any way characterize, or otherwise limit, the '798 application or any of the diverse embodiments, implementations, and/or examples disclosed therein.

The '798 application discusses, in accordance with some embodiments, generating/synthesizing a predicted point cloud frame, PC_{pred}, according to estimated motion, followed by extracting its feature map as the predicted feature F_{pred}. As such, the '798 application, in accordance with some embodiments, performs a generative-based predictive coding for point cloud compression (PCC).

Unlike the D-DPCC of Fan, the '798 application follows the physics/dynamics of point cloud sequences. Moreover, unlike both Fan and Akhtar, which are based on residual coding (see FIG. 5), the '798 application, in accordance with some example embodiments, adopts a conditional coding paradigm, which encodes the feature map of the current frame F_{cur} condition on the same information commonly known on the encoder and the decoder side, such as the predicted feature, F_{pred}.

According to Ladune, Theo, et al., Optical Flow and Mode Selection for Learning-Based Video Coding, 2020 IEEE 22ND INTERNATIONAL WORKSHOP ON MULTIMEDIA SIGNAL PROCESSING (MMSP), IEEE (2020), ARXIV PREPRINT ARXIV: 2008.02580v1 (2020) (“Ladune”), conditional coding provides better compression performance than residual coding. Conditional coding also permits a more flexible architectural design, which better tailors the unstructured format of 3D point clouds.

For some embodiments, this application addresses the problem of dynamic point cloud compression (D-PCC). Unlike other D-PCC configurations, which may compress a current point cloud frame given a reference point cloud frame, the present application discusses, in accordance with some example embodiments, explicitly generating a predicted point cloud frame for both the encoder and the decoder. To further enhance compression performance, the present application discusses, in accordance with some example embodiments, applying a conditional coding paradigm to compress the current point cloud frame conditioned on the predicted point cloud frame. For some embodiments, such a condition not only includes the predicted point cloud frame but also the hidden memory generated during motion estimation.

The example design in the '798 application relies on the convolutional neural network (CNN) backbone based on a voxel-based representation. Example designs of the '798 application are understood to work more optimally when the points in the input point cloud sequences are densely distributed, e.g., when the input point cloud sequences are dense point clouds sequences for AR/VR applications. However, given sparse LiDAR point cloud sequences as inputs, the CNN backbone of the '798 application is understood to be less optimal for some implementations because the input points are sparsely distributed. To resolve these challenges, the design of the '798 application is extended by inputting the input point clouds into point-based neural networks. As a result, the same methodology may be applied to sparse LiDAR point cloud sequences.

This application has similarities to the '798 application, but as just mentioned, a point-based neural network is used to handle the use case of sparse LiDAR point cloud sequences. Thus, in accordance with some example embodiments disclosed herein, the input point cloud PC_{cur}, the reference point cloud PC_{ref}, the predicted point cloud PC_{pred}, and the decoded point cloud [symbol] , are all represented with point-based representations.

Similar to Fan and Akhtar, according to example embodiments, the '798 application's deep-learning-based D-PCC examples method may also include, e.g., three parts: (i) a block partition coding branch, which is shown in FIG. 3; (ii) a predictor generation branch, which is shown in FIG. 7; and (iii) a feature coding branch, which is shown in FIG. 8. These three branches generate three bitstreams: BS_{blk}, BS_{T}, and BS_{feat}. These three bitstreams may be combined as one bitstream for transmission and/or storage. The block partition coding branch for the present application in accordance with some example embodiments, is the same as that being used in Fan and Akhtar. Thus, in some embodiments, only the predictor generation branch (FIG. 7) and the feature coding branch (FIG. 8) are added here, utilizing point-based neural networks.

### Predictor Generation

FIG. 7 is a block diagram illustrating an example predictor generation branch according to some embodiments. The predictor generation branch 700 performs motion estimation between the current point cloud frame, PC_{cur}, and a reference point cloud frame, PC_{ref}, followed by encoding the motion information for predictor generation on both the encoder and the decoder. The current point cloud frame PC_{cur} and the reference point cloud frame PC_{ref} are inputted into a transformation feature extractor 702, which aggregates and down-samples for 2™ times via both a point-based neural network and a convolutional neural networks (CNN), and outputs a 3D sparse tensor, F_{T}. The CNN is used, e.g., to extract F_{T}. The 3D feature tensor, F_{T}, is an abstract feature map that includes motion/transformation information between PC_{cur} and PC_{ref}. The coordinates of the sparse tensor, F_{T}, are aligned with the block coordinates, B_{cur}, which may occur via a feature serialization block 704. The 3D feature tensor, F_{T}, is quantized and entropy encoded by an arithmetic encoder (AE) 706 to generate an encoded transformation bitstream BS_{T}. On the right side of FIG. 7, the arithmetic decoder (AD) 708 decodes the bitstream, BS_{T}, and the sparse tensor construction block 710 incorporates the block coordinates, B_{cur}, to reconstruct the transformation feature map, denoted as F_{T}, which may be considered a quantized version of F_{T}. IT is inputted into the predicted point cloud generator 712.

Similar to the '798 application, the present application discusses, in accordance with some example embodiments, generating/synthesizing a predicted point cloud, PC_{pred}, by processing the point cloud, PC_{ref}, according to the transformation feature map. However, for some embodiments, the predicted point cloud generator operates under a point-based representation, which counts the sparsity of LiDAR point clouds. The predicted point cloud, PC_{pred}, is inputted into a predicted feature extractor 714 for extracting the predicted feature map, F_{pred}, in which the predicted feature extractor is also a point-based neural network, unlike a CNN-based predicted feature extractor in some applications. The predicted feature map, F_{pred}, serves as a predictor to facilitate coding of the current point cloud frame, PC_{cur}. The predicted feature map, F_{pred}, is generated on both the encoder and decoder sides.

In Fan, a “Motion Decoder” block converts \hat{F}_{T} into a set of motion vectors, M. The motion vectors, M, may be used to warp the feature map of the reference point cloud frame, F_{ref}, to form the predicted feature map, F_{pred}. However, in the predictor generation branch of FIG. 7, the decoder instead uses \hat{F}_{T} (which may be considered a feature map of the motion between PC_{ref} and PC_{cur}) to directly predict the current point cloud. The predicted feature extractor extracts features from the prediction (PC_{pred}), to get the predicted feature vector, pred. The final output of the predictor generation branch of FIG. 7 is F_{pred}.

For some embodiments, generating a predicted point cloud PC_{pred} as an intermediate step has two key advantages. Firstly, by warping the reference point cloud, PC_{ref}, according to estimated motion or transformation, the true physics of the dynamic point cloud sequences are followed, which is more natural. Therefore, certain example embodiments described in this application may have a better chance to improve compression performance. Secondly, the predicted point cloud PC_{pred} may be directly supervised by the current point cloud, PC_{cur}, during a training stage, which makes convergence easier in the training phase compared to D-DPCC.

### Feature Coding

FIG. 8 is a block diagram illustrating an example feature coding branch according to some embodiments. This application describes, in accordance with some example embodiments, applying a conditional coding paradigm to compress the current point cloud frame, PC_{cur}. Firstly, in the feature coding branch 800 of FIG. 8, the current point cloud frame, PC_{cur}, is inputted into a point cloud encoder 802 to extract a feature map, F_{cur}. The feature map is a high-level/abstract representation of PC_{cur}. For some embodiments, the point cloud encoder 802 may be a point-based neural network to count the sparsity of LiDAR point clouds. Instead of compressing PC_{cur} directly, the present application, in accordance with some example embodiments, compresses the high-level representation, F_{cur}. To do so, the feature map, F_{cur}, is further processed/aggregated by a conditional encoder 804 using the predicted feature map, F_{pred}, to generate a conditional feature map, Fond. The conditional feature map may be aligned with block coordinates, B_{cur}, via a feature serialization block 806. The (aligned) conditional feature map is quantized and then entropy encoded by an arithmetic encoder (AE) 808 to generate the feature bitstream, BS_{feat}.

On the right side of FIG. 8, an arithmetic decoder (AD) 810 decodes the bitstream, BS_{feat}, and a sparse tensor construction block 812 incorporates the block coordinates, B_{cur}, to reconstruct the conditional feature map, denoted as \hat{F}_{cnd}. For some embodiments, the conditional feature map is a quantized version of F_{cnd}. The reconstructed conditional feature map, \hat{F}_{cnd}, is inputted into the conditional decoder 814. The conditional decoder 814 takes the predicted feature map, F_{pred}, as a condition and outputs \hat{F}_{cur}, the reconstructed feature map of the current point cloud. The reconstructed conditional feature map, \hat{F}_{cur}, \hat{F}_{cur}, is inputted into a point cloud decoder 816 to reconstruct the decoded point cloud, [symbol] _{cur}. For some embodiments, the point cloud decoder may be a point-based neural network utilizing MLP layers.

F_{pred} is a predicted feature map and is a prediction of the current point cloud but in the same “feature space” as F_{cur}. See FIG. 7 for details on how F_{pred} is generated. F_{cur} is a “feature map” for the current point cloud, [symbol] _{cur}. Compare FIGS. 5 and 8. \hat{F}_{cnd} is a decoded version of F_{cnd}, which is a conditionally encoded version of F_{cur}. \hat{F}_{cur} is recovered by conditionally decoding \hat{F}_{cnd} and using F_{pred} as the conditional data. \hat{F}_{cur} is a reconstructed version of the “feature map” F_{cur}, which carries the features of the current point cloud frame. A point cloud decoder network translates from the feature space, which is denoted here as \hat{F}_{cur}, into the spatial cloud domain.

Unlike the D-DPCC of Fan, the point cloud encoder in the feature coding branch (FIG. 8) may have a different structure from the predicted feature extractor in the predictor generation branch (FIG. 7) thanks to usage of the conditional coding paradigm. In fact, the numerical values of \hat{F}_{cur} may be very different from F_{cur}, and even their feature dimensionality (number of channels) may be different (though the coordinates should be aligned for B_{cur}). For some embodiments, using a conditional coding paradigm has two main advantages. Firstly, according to Ladune, the entropy of residue coding is greater than or equal to that of conditional coding, which means the compression performance of conditional coding is better than the traditional residual coding. Secondly, conditional coding offers higher flexibility to incorporating other known information for compressing 3D point clouds. An example discussed below exploits hidden memory generated by the transformation feature extractor, which is used as an additional condition for both conditional encoding and decoding.

The present application in accordance with some example embodiments, generates F_{pred} in a different way than Fan. See, for example, the explanation related to FIG. 7 and compare the prediction generation branch of FIG. 4 with the prediction generation branch of FIG. 7. Fan takes a difference between F_{pred} and F_{cur} and codes the residual signal. Compare the feature coding branch of FIG. 5 with the feature coding branch of FIG. 8. The present application uses, in accordance with some example embodiments, a conditional encoder to encode F_{cur} conditioned on F_{pred}. No residual signal is used in FIG. 8 in accordance with some embodiments. A corresponding conditional decoder is used on the client side, which is shown on the right side of FIG. 8.

### Transformation Feature Extractor

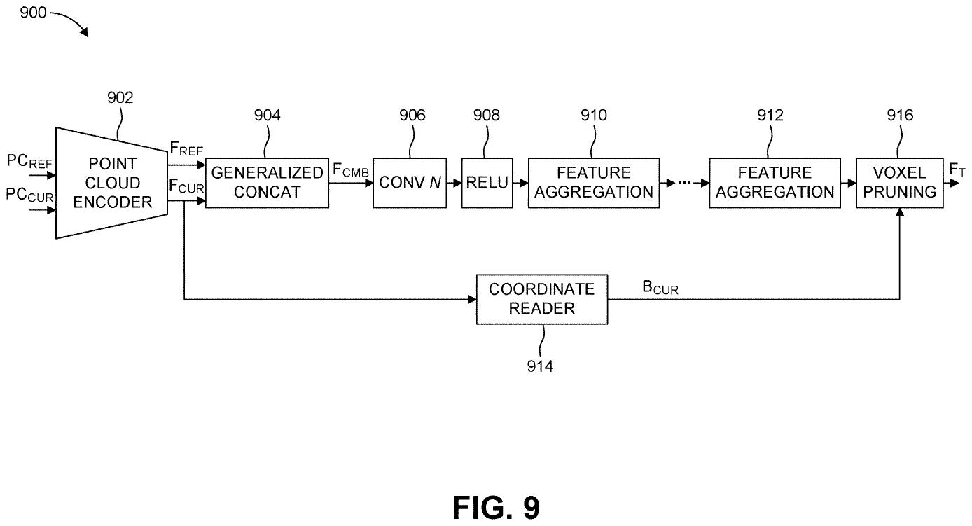

FIG. 9 is a block diagram illustrating an example transformation feature extractor according to some embodiments. The transformation feature extractor 900 takes both the current point cloud PC_{cur} and the reference point cloud PC_{ref} as inputs and generates a transformation feature map, F_{T}, which represents the dynamics between the two point clouds. Firstly, both PC_{cur} and PC_{ref} are inputted into the point cloud encoder 902. The point cloud encoder 902 extracts the features from them using point-based neural networks, which generates two different feature maps. For some embodiments, the point cloud encoder 902 is the same one used in the feature coding branch (an embodiment of which is shown in FIG. 8). Thus, the extracted feature maps representing PC_{cur} and PC_{ref} are F_{cur} and F_{ref}, respectively.

The two extracted feature maps are concatenated together by a generalized concatenation block 904, which outputs a combined feature map, F_{cmb}. While the sparse tensor, F_{cur}, has coordinates from B_{cur}, the reference feature map, F_{ref}, may not. Thus, for some embodiments, a simple concatenation operation with the sparse tensor would not work. In Fan, a generalized concatenation operation is defined to handle concatenation, which will also be applied to the present application in accordance with some example embodiments. If the coordinates of F_{ref} are B_{ref}, then the concatenated feature vector at a 3D coordinate u is indicated as:

$${F}_{cmb} ( u ) = \{ \begin{matrix}Concat ( {F}_{cur} ( u ) , {F}_{ref} ( u ) ) & u ∈ {B}_{cur} ⋂ {B}_{ref} \\ Concat ( 0 , {F}_{ref} ( u ) ) & u ∉ {B}_{cur} and u ∈ {B}_{ref} \\ Concat ( {F}_{cur} ( u ) , 0 ) & u ∈ {B}_{cur} and u ∉ {B}_{ref}\end{matrix} \qquad Eq . 3$$

in which u∈B_{cur}∪B_{ref}, 0 is a vector with all zeros. Function “Concat” is a regular vector concatenation operation. F_{cur}(u) is the feature vector of F_{cur} defined at u, similarly for F_{ref}(u) and F_{cmb}(u). The coordinates of F_{cmp} become the union of B_{cur} and B_{ref}, which is denoted as B_{cur}∪B_{ref}.

The combined feature, F_{cmb}, is inputted into a 3D sparse convolution layer 906, which converts the feature dimension to N, followed by a ReLU activation function 908. The output is passed to a series of feature aggregation blocks 910, 912. The feature aggregation blocks 910, 912 further aggregate and refine the features. The feature aggregation blocks 910, 912 do not change the dimensionality (number of channels) of an input tensor. The details of the feature aggregation block are discussed below. Finally, the voxels that do not belong to Bour are removed by a voxel pruning block 916. The block coordinates, Bur, may be generated by a coordinate reader 914. The output of the voxel pruning block is a transformation feature map, F_{T}.

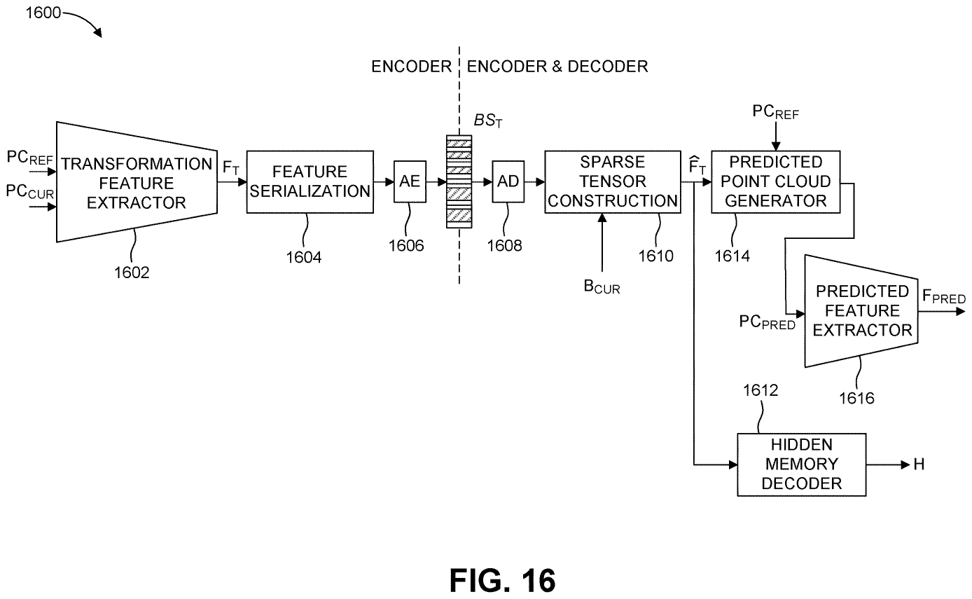

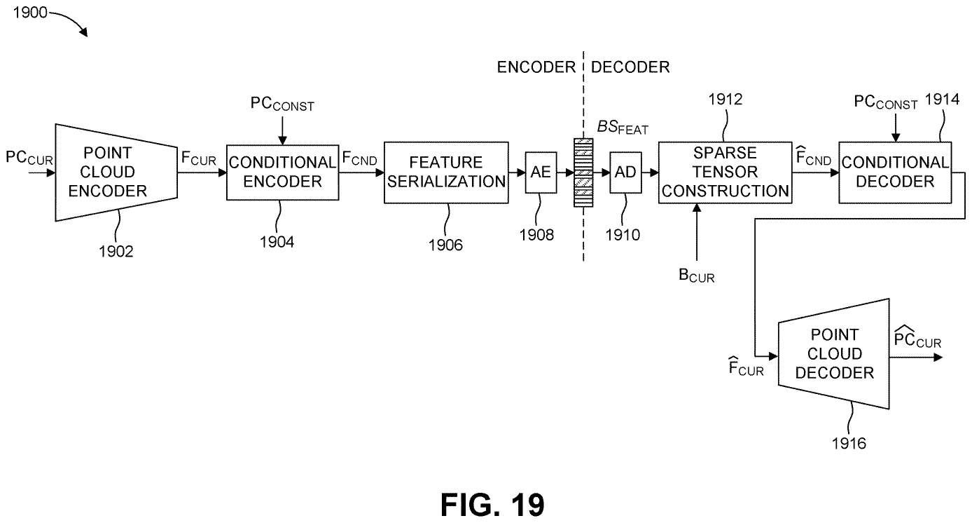

The transformation feature extractor of FIG. 9 is used within the predictor generation branch, which is shown in FIGS. 4 and 7, as well as FIGS. 16, 19A, and 19B. The 3D sparse tensor output, F_{T}, is the “transformation feature map.” F_{T} is an “abstract feature map,” which represents the motion/transformation between PC_{cur} and PC_{ref}.

### Predicted Point Cloud Generator

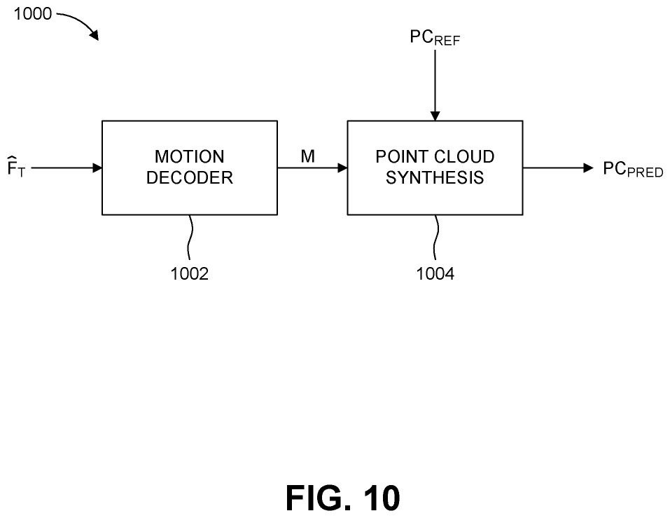

FIG. 10 is a block diagram illustrating an example predicted point cloud generator according to some embodiments. The predicted point cloud generator 1000 takes as input the reconstructed transformation feature map, \hat{F}_{T}, and the reference point cloud frame, PC_{ref}, and outputs a predicted point cloud frame, PC_{pred}. For some embodiments, the predicted point cloud generator includes two blocks, a motion decoder block 1002 and a point cloud synthesis block 1004, as shown in FIG. 10.

For some embodiments, a motion decoder may take as input the reconstructed transformation feature map, F_{T}, and determine a motion field, M, for the occupied point cloud blocks. The point cloud synthesis block takes as inputs the reference point cloud frame, PC_{ref}, and the motion field, M, and generates the predicted point cloud, PC_{pred} Compared to the proposal of Fan and Akhtar, where a predicted point cloud is never synthesized, generating a predicted point cloud based on the motion follows the true physics of a dynamic point cloud sequence. Additionally, compared to a point cloud synthesis that only takes a reference point cloud frame as input, there are at least two advantages for a point cloud synthesis with a motion field as an additional input: (1) the predicted point cloud may be more accurate; and (2) the computational complexity may be decreased. The motion decoder shown in FIG. 10 may be the same as the motion decoder of FIG. 4.

For some embodiments, FIG. 10 is a block diagram of the predicted point cloud generator that fits within the predictor generation branch shown in FIG. 7. The reconstructed transformation feature map, \hat{F}_{T}, is essentially a feature map of the motion differences between PC_{ref} and PC_{cur} for some embodiments, \hat{F}_{T} is used with a decoded version of the reference point cloud to directly predict/generate the current point cloud.

### Motion Decoder

FIG. 11 is a block diagram illustrating an example motion decoder according to some embodiments. As mentioned above, for some embodiments, a motion decoder may take as input the reconstructed transformation feature map, ÊT, and determine a motion field, M, for the occupied point cloud blocks. For some embodiments, the motion decoder 1100 may include a series of feature aggregation blocks 1102, 1104 for aggregation and refinement, followed by a 3D sparse convolutional layer 1106 with 3 output channels. The 3D sparse convolutional layer 1106 produces a 3D motion vector for each occupied block in B_{cur}. For instance, for a block position u∈B_{cur}, the 3D sparse convolutional layer produces a motion vector vᵤ equal to (xᵤ, yᵤ, zᵤ). Such motion vectors together form the motion field, M. Due to the structure of the motion vector, the block located at vᵤ+u in the reference point cloud may resemble the block located at position u of the current point cloud.

For some embodiments, FIG. 11 is a block diagram of the motion decoder 1100, 1002 that fits within the predicted point cloud generator 1000 shown in FIG. 10. As mentioned above, F_{T}, is essentially a feature map of the motion differences between PC_{ref} and PC_{cur} for some embodiments. Furthermore, F_{T}, is essentially an abstract representation generated by a neural network for some embodiments. The motion decoder generates a motion field, M, from F_{T}. The motion field may include motion vectors for the occupied point cloud blocks, which are indicated in Bour. B_{cur} is discussed with regard to FIG. 3 as part of the block coding branch.

### Point Cloud Synthesis

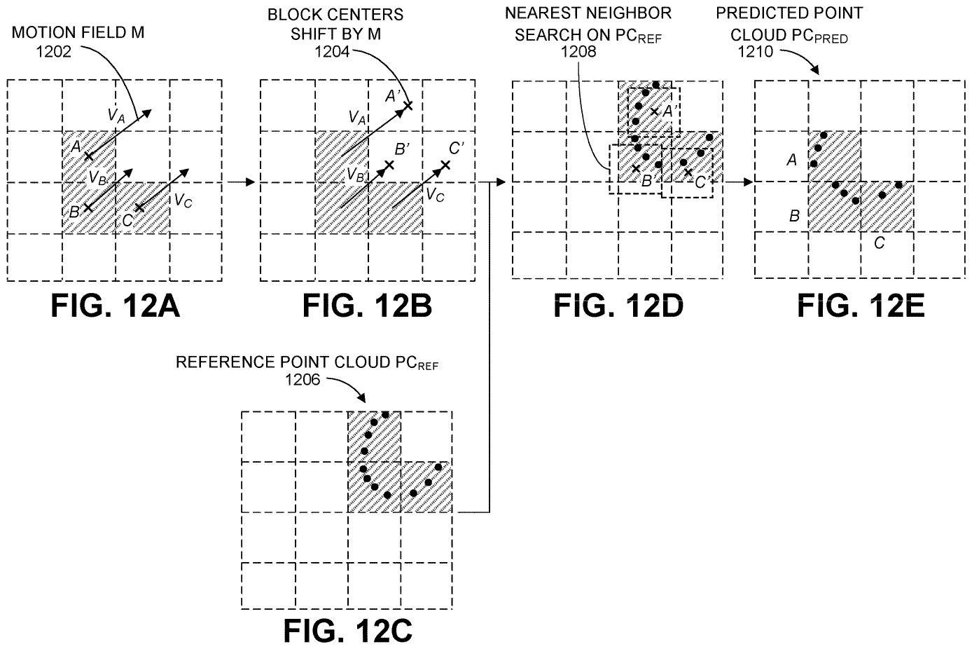

FIGS. 12A-12E are process diagrams illustrating an example predicted point cloud synthesis process according to some embodiments. The point cloud synthesis block takes as inputs the reference point cloud frame, PC_{ref} 1206, and the motion field, M 1202, and generates the predicted point cloud, PC_{pred} 1210. Different from the point cloud synthesis in the '798 application operating in the voxel-based representation, the point cloud synthesis in the present application, for some embodiments, operates in a point-based representation. Likewise, unlike the '798 application, which in some embodiments created a predicted point cloud via interpolation, here, for some embodiments, here the predicted point cloud is created via nearest neighbor search.

The reference point cloud 1206 is translated according to the motion vectors in M. An illustrative example is provided in FIGS. 12A-12E. FIG. 12A shows the motion field, M 1202. The three blocks of FIG. 12A labeled A, B, and C are the occupied blocks and their (blockwise) motion vectors are v_{A}, v_{B}, and v_{C}, respectively.

The block centers in FIG. 12A (referred to as A, B, and C) are translated/shifted according to their respective motion vectors. The 3D coordinates of v_{A}, v_{B}, and v_{C} are added, respectively, to the 3D coordinates of A, B, and C, leading to three points A′, B′, and C′ 1204, as shown in FIG. 12B. FIG. 12C shows a reference point cloud, PC_{ref} 1206, in which the shaded occupied blocks include points.

A nearest neighbor search 1208 is performed on the reference point cloud PC_{ref}, centering at the translated points A′, B′, and C′, as shown in FIG. 12D. For some embodiments, such as is shown by FIG. 12D, the nearest-neighbor search 1208 looks for points lying within square-shaped blocks around A′, B′, and C′, which are shown as three black line squares in FIG. 12D. For some embodiments, a nearest-neighbor search may look for points in PC_{ref} that are within a certain Euclidean distance (radius) from A′, B′, and C′.

In FIG. 12E, the acquired points associated with A′, B′, and C′ are translated/shifted back to the blocks A, B, and C according to their respective motion vectors. For instance, suppose the nearest neighbor points associated with A′ are

$${x}_{i}^{A ′}$$

for i=1, 2, . . . , k_{A}. The nearest neighbor points are shifted back to the neighborhood of A, by subtracting from them the motion vector v_{A}, leading to Eq. 4:

$${x}_{i}^{A} = {x}_{i}^{{A}^{′}} - {v}_{A} , for i = 1 , 2 , … , {k}_{A} . \qquad ( 4 )$$

A similar process may be done for the point sets associated with B′ and C′. Together, the translated point sets

$${\{ {x}_{i}^{A} \}}_{i = 1}^{{k}_{A}} , {\{ {x}_{i}^{B} \}}_{i = 1}^{{k}_{B}} , and {\{ {x}_{i}^{C} \}}_{i = 1}^{{k}_{C}} ,$$

form the predicted point cloud PC_{pred}. In the general case, when there are b points u₁, u₂, . . . , u_{b} in current block positions B_{cur}, the translated point sets

$${\{ {x}_{i}^{{u}_{1}} \}}_{i = 1}^{{k}_{{u}_{1}}} , {\{ {x}_{i}^{{u}_{2}} \}}_{i = 1}^{{k}_{{u}_{2}}} , … , {\{ {x}_{i}^{{u}_{b}} \}}_{i = 1}^{{k}_{{u}_{b}}}$$

together form the predicted point cloud PC_{pred} 1210, leading to Eq. 5:

$$P {C}_{pred} = {\{ {x}_{i}^{{u}_{1}} \}}_{i = 1}^{{k}_{{u}_{1}}} ⋃ {\{ {x}_{i}^{{u}_{2}} \}}_{i = 1}^{{k}_{{u}_{2}}} ⋃ … ⋃ {\{ {x}_{i}^{{u}_{b}} \}}_{i = 1}^{{k}_{{u}_{b}}} . \qquad ( 5 )$$

### Point Cloud Encoder

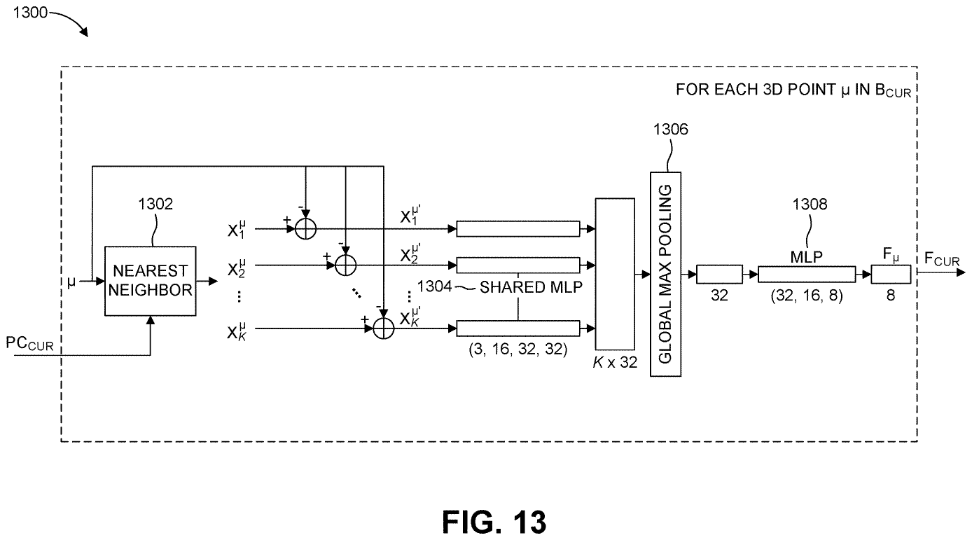

FIG. 13 is a process diagram illustrating an example point cloud encoder according to some embodiments. The point cloud encoder 1300 extracts from a point cloud PC_{cur}, a feature map F_{cur}, which is a high-level/abstract representation of PC_{cur}. In contrast to the point cloud encoders used in journal article Wang, Jianqiang, et al., Multiscale Point Cloud Geometry Compression, 2021 DATA COMPRESSION CONFERENCE (DCC), IEEE (2021) (“Wang”) or the '798 application, the example point cloud encoder 1300 of the present application, for some embodiments, is based on a point-based neural network and follows some example designs of the '087 application, an example of which is shown in FIG. 13.

For each 3D point u in Bur, a search is performed by a nearest neighbor block 1302 to look for the k-nearest neighbors in PC_{cur}. These k points are denoted as

$${x}_{1}^{u} , {x}_{2}^{u} , … , {x}_{k}^{u} .$$

The point u is subtracted from

$${x}_{1}^{u} , {x}_{2}^{u} , … , {x}_{k}^{u} ,$$

leading to the points

$${x}_{1}^{{u}^{′}} , {x}_{2}^{{u}^{′}} , … , {x}_{k}^{{u}^{′}} ,$$

respectively. Such subtraction is pointwise subtraction. e.g., subtracting u from

$${x}_{1}^{u}$$

subtracts the (x, y, z) coordinates of u from the (x, y, z) coordinates of

$${x}_{1}^{u} ,$$

respectively. The value of k is chosen based on the density level of the input point cloud, PC_{cur}. Typically, for a sparse LiDAR point cloud, the value of k may be small, such as k=5. The distance metric used by the k-Nearest Neighbors (kNN) search may be any distance metric, such as L-1 norm, L-2 norm, and/or L-infinity norm.

A 3D sparse tensor includes a set of coordinates (or positions), and on each of these positions, there is a feature vector. Here, the coordinates of F_{cur} are Bour, in which B_{cur} is the set of block coordinates for the current point cloud. At each coordinate/position of F_{cur}, there is a feature vector describing the local geometry of that position. The feature vectors of F_{cur} together form a feature map that describes the geometry of the current point cloud.

The points

$${x}_{1}^{{u}^{′}} , {x}_{2}^{{u}^{′}} , … , {x}_{k}^{{u}^{′}}$$

may be processed by deep neural network layers, which output a feature vector fᵤ describing the local geometry of PC_{cur}. For some embodiments, the deep neural network applies the PointNet architecture described in journal article Qi, Charles R., et al., PointNet: Deep Learning on Point Sets for 3D Classification and Segmentation, PROC. OF THE IEEE CONFERENCE ON COMPUTER VISION AND PATTERN RECOGNITION (2017). FIG. 13 shows a set of shared MLPs 1304 operating on each of the 3D points

$${x}_{1}^{{u}^{′}} , {x}_{2}^{{u}^{′}} , … , {x}_{k}^{{u}^{′}} .$$

The MLPs 1304 output a set of points, which are inputted into a global max pooling operator 1306. The global max operator 1306 extracts a global feature vector. This global feature vector is further processed by another set of MLP layers 1308, leading to the output feature vector fᵤ. The set of feature vectors fᵤ for all the points u in B_{cur} form the output feature map F_{cur}.

The numbers “(3, 16, 32, 32)” shown in FIG. 13 under the shared MLP layers 1304 indicate the number of channels/dimension of the MLP layers. For some embodiments of the example shown in FIG. 13, the first layer takes 3 channels (the (x, y, z) coordinate) as its input and converts the input to 16 channels. The next layer converts the 16-channel tensor to a 32-channel tensor. The last layer converts the 32-channel tensor to another 32-channel tensor. Hence, the output shown in FIG. 13 is a k-by-32 matrix. These numbers shown in FIG. 13 are merely an example. The shared MLP 1304 and output matrix may be selected and/or designed to have other dimensions.

For some embodiments, if a point cloud encoder is applied to extract the feature of the reference point cloud PC_{ref} (as shown in FIG. 9, for example) thereby leading to its feature F_{ref}, the term Bour used with FIG. 13 is replaced with B_{ref}, which is a set of block coordinates from the reference point cloud, PC_{ref}. As a result, instead of operating over the 3D points of B_{cur}, the paradigm of FIG. 13 operates over the block coordinates of the reference point cloud PC_{ref}.

### Point Cloud Decoder

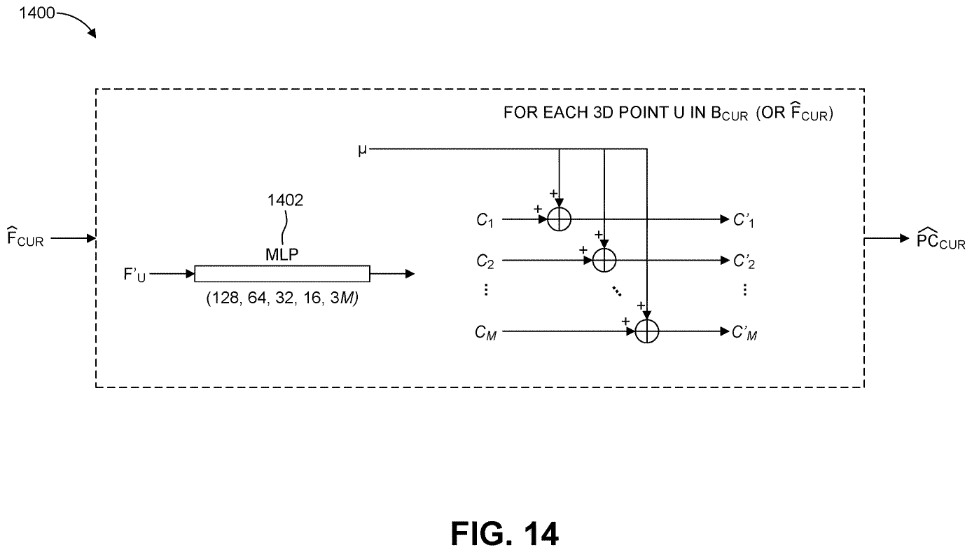

FIG. 14 is a process diagram illustrating an example point cloud decoder according to some embodiments. Given the decoded current feature map \hat{F}_{cur}, the point cloud decoder 1400 reconstructs the current point cloud [symbol] _{cur}. In contrast to the point cloud decoders used in Wang or the '798 application, this point cloud decoder 1400 is based on a point-based neural network. The example point cloud decoder of the present application, for some embodiments, is based on a point-based neural network and follows some example designs of the '087 application, an example of which is shown in FIG. 14.

A feature vector of \hat{F}_{cur}, denoted as f′ᵤ, is inputted into a series of MLP layers 1402. The MLP layers 1402 directly output a set of m 3D points, c₁, c₂, . . . , cₘ. For some embodiments, the number of decoded points m may be a fixed constant. For instance, if PC₀ is very sparse, the value for m may be set to be a small number, such as m=2. For some embodiments, the 3D points in c₁, c₂, . . . , cₘ that are too far away from the origin may be removed. Specifically, for a point cᵢ, if its distance to the origin is larger than a threshold t, point ca is considered an outlier and removed. The threshold t may be a predefined constant.

The points c₁, c₂, . . . , cₘ are summed with their associated point u in B_{cur} to obtain the new 3D points c′₁, c′₂, . . . , c′ₘ, as shown in FIG. 14. The summation shown in FIG. 14 is a pointwise summation, e.g., the (x, y, z) coordinates of the two 3D points are summed, respectively. For B_{cur} with b 3D points, this procedure ends up with b×m points in total. These b×m points together give the decoded point cloud [symbol] _{cur}.

### Predicted Feature Extractor

A predicted feature extractor takes a predicted point cloud PC_{pred} as an input and generates a predicted feature F_{pred}. In some embodiments, such a predicted feature extractor may use the same architecture as a point cloud encoder, such as the example architecture shown in FIG. 13. However, instead of re-launching a nearest-neighbor search, the nearest neighbors obtained when constructing PC_{pred}, as shown in Eq. (2), may be re-used. For instance, given the position u₁ from B_{cur}, its associated nearest neighbors in PC_{pred} are the 3D points

$${\{ {x}_{i}^{{u}_{1}} \}}_{i = 1}^{{k}_{{u}_{1}}}$$

in PC_{pred}. The rest of the steps to obtain F_{pred} may be the same as illustrated in FIG. 13, in accordance with some embodiments.

### Conditional Encoder and Decoder

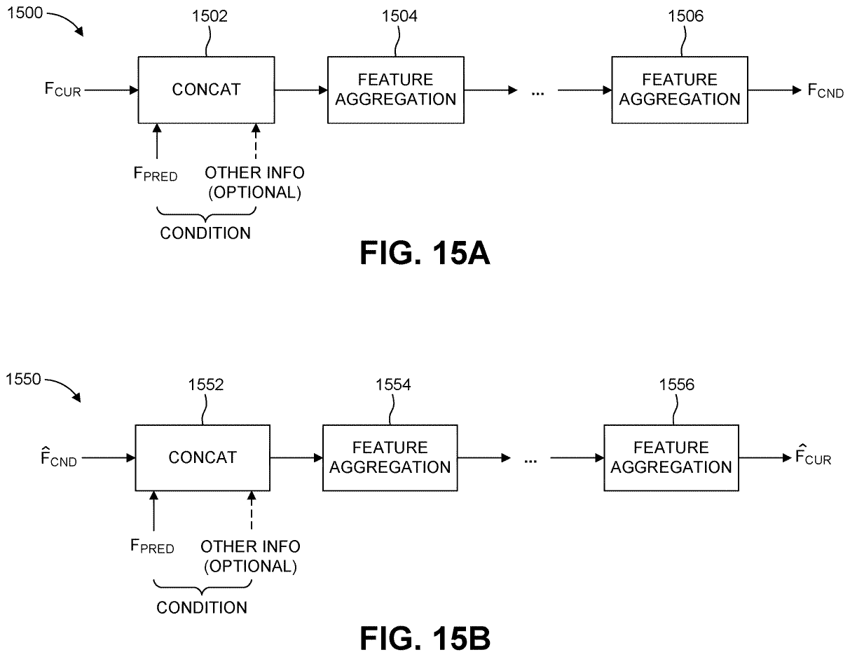

FIG. 15A is a block diagram illustrating an example conditional encoder according to some embodiments. Given a set of input conditions, the conditional encoder 1500 converts the current point cloud feature, F_{cur}, to a conditional feature map, Fond. For some embodiments, the input condition is F_{pred}. For some embodiments, the input conditions are F_{pred} and other information used for encoding and decoding if such information exists. The conditional encoder 1500 decouples/removes from F_{cur} redundant information that is included in the conditions. The conditional encoder 1500 outputs the conditional feature map, F_{cnd}, which may be easier to compress. The current point cloud feature, F_{cur}, is concatenated 1502 with the input conditions. A series of one or more feature aggregation blocks 1504, 1506 may be applied to the output of the concatenation to refine the feature map. The output of the one or more feature aggregation blocks 1504, 1506 is a conditional feature map, F_{cnd}.

FIG. 15B is a block diagram illustrating an example conditional decoder according to some embodiments. For some embodiments, the conditional decoder 1550 has a similar structure as the conditional encoder. The conditional decoder 1550 merges known information from the conditions with the reconstructed conditional feature map, F_{cnd}, to reconstruct the current point cloud feature map, \hat{F}_{cur}. For some embodiments, the input condition is F_{pred}. For some embodiments, the input conditions are F_{pred} and other information used for encoding and decoding if such information exists. The reconstructed conditional feature map, \hat{F}_{cnd}, IS concatenated 1552 with the input conditions. A series of one or more feature aggregation blocks 1554, 1556 may be applied to the output of the concatenation to refine the feature map. The output of the one or more feature aggregation blocks is the reconstructed current feature map, \hat{F}_{cur}.

For some embodiments, FIGS. 15A and 15B are block diagrams of the conditional encoder and decoder, respectively, that fit within the feature coding branch shown in FIG. 8. FIGS. 15A and 15B show the additional details of the conditional encoder and decoder, respectively. The conditional encoding removes from F_{cur} redundant information included in the conditional data. For some embodiments, the conditional data may be F_{pred}. F_{cur} is an abstract feature-level representation of the current point cloud. The conditional encoder produces F_{cnd}, which may be easier to compress than F_{cur}. Conversely, the conditional decoder adds to \hat{F}_{cnd} information which may be included in the conditional data. The conditional decoder produces Êcur as an output.

### Feature Aggregation

In some example embodiments of the present application, the feature aggregation block is a building block in the example neural network architecture. The feature aggregation block is also a general block used in many works related to 3D point cloud processing. Given an input sparse tensor, the feature aggregation block refines/improves the representability of a feature map by aggregating features while keeping the same feature dimension.

Multiple options exist for the feature aggregation block. For some embodiments, the feature aggregation block is a series of sparse 3D convolutional layers with a ReLU activation function following each 3D convolutional layer. For some embodiments, the feature aggregation block uses a ResNet architecture (See He, Kaiming, et al., Deep Residual Learning for Image Recognition, PROCEEDINGS OF THE IEEE CONFERENCE ON COMPUTER VISION AND PATTERN RECOGNITION, IEEE (2016)). Compared to the previous design, some embodiments introduce a residual connection from the input, which is added to the output of the convolutional layers. For some embodiments, the feature aggregation block uses an Inception-ResNet (IRN) architecture (See Wang), which is an improved version of the ResNet architecture. For some embodiments, the feature aggregation block uses a voxel transformer architecture, which utilizes a self-attention mechanism to discover long-range dependency in the input feature map. See Mao, Jiageng, et al., Voxel Transformer for 3D Object Detection, PROCEEDINGS OF THE IEEE/CVF INTERNATIONAL CONFERENCE ON COMPUTER VISION, IEEE (2021).

Reference is made to the '212 application (incorporated herein by reference) for more example explanation regarding the feature aggregation block and examples of the feature aggregation block.

### Hidden Memory as an Additional Condition

FIG. 16 is a block diagram illustrating an example predictor generation branch with hidden memory according to some embodiments. The current point cloud frame PC_{cur} and the reference point cloud frame PC_{ref} are inputted into a transformation feature extractor 1602, which aggregates and down-samples for 2ₘ times via both a point-based neural network and a convolutional neural networks (CNN), and outputs a 3D sparse tensor, F_{T}. The CNN is used, e.g., to extract F_{T}. The 3D feature tensor, F_{T}, is an abstract feature map that includes motion/transformation information between PC_{cur} and PC_{ref}. The coordinates of the sparse tensor, F_{T}, are aligned with the block coordinates, B_{cur}, which may occur via a feature serialization block 1604. The 3D feature tensor, F_{T}, is quantized and entropy encoded by an arithmetic encoder (AE) 1606 to generate an encoded transformation bitstream BS_{T}. On the right side of FIG. 16, the arithmetic decoder (AD) 1608 decodes the bitstream, BS_{T}, and the sparse tensor construction block 1610 incorporates the block coordinates, B_{cur}, to reconstruct the transformation feature map, denoted as F_{T}, which may be considered a quantized version of F_{T}. ÊT is inputted into the predicted point cloud generator 1614. The predicted point cloud, PC_{pred}, is inputted into a predicted feature extractor 1616 for extracting the predicted feature map, F_{pred}.

The term “hidden memory” refers to an intermediate quantity that may not be exposed to either the input or the final output. The term comes from the terminology used with a neural network architecture in which there may be input and output layers with an intermediate layer in between. Motion estimation produces a predicted point cloud, PC_{pred}, and a predicted feature map, F_{pred}, which are shown in FIG. 7. For example, when a motion vector of an occupied block located at a 3D position, u, is inaccurate, then the predicted feature located at u, which is F_{pred}(u), does not contain “helpful” information for the encoding/decoding of F_{cur}(u).

In such a scenario, the conditional encoder/decoder (FIG. 8) may be less dependent on F_{pred}(u) to compress F_{cur}(u). This observation is based on an overall design performance improvement. Also, such a scenario illustrates a scenario when hidden memory may be “helpful.” When a motion vector u is not reliable, then the predicted feature at location u, which may be expressed as F_{pred}(u), also is not reliable. As a result, using F_{pred}(u) as a condition for conditional coding may be inefficient in such a scenario. Ideally, the conditional encoder and conditional decoder (shown in FIG. 8) are able to determine the reliability of the feature vectors in F_{pred}. If a predicted feature vector, F_{pred}(u), is high quality, then the conditional encoder and conditional decoder may reliably use F_{pred}(u) to serve as a condition to process F_{cur}(u). However, if a predicted feature vector, F_{pred}(u), is low quality, then the conditional encoder and conditional decoder may ignore F_{pred}(u) and encode and decode F_{cur}(u) independently. Without hidden memory, a neural network may be unable to determine the quality of F_{pred}(u). The hidden memory, H, may provide some indication/side information on the quality of motion estimation. As a result, conditional encoding and conditional decoding may be more robust and/or efficient for compression.

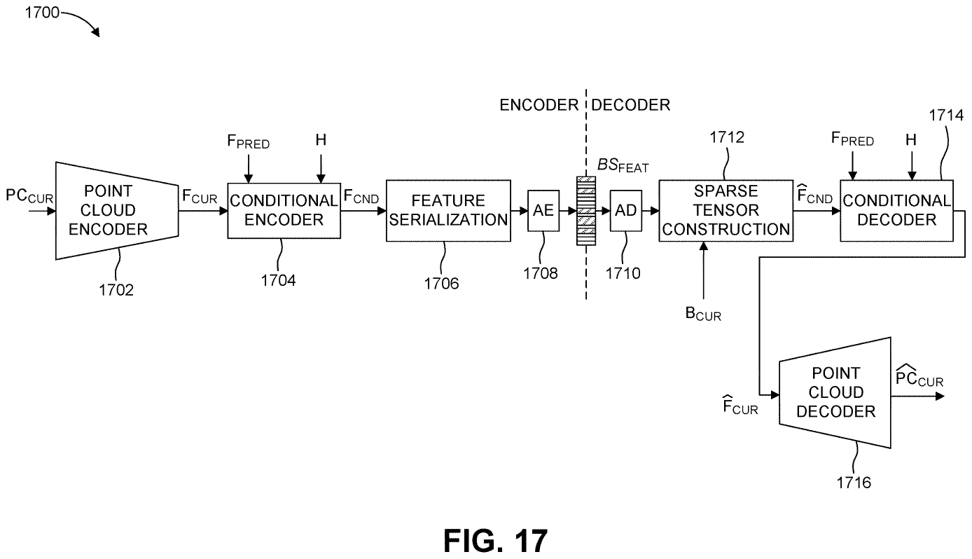

For some embodiments, an additional quantity may be included for conditional coding by making two architecture changes, which are shown in FIGS. 16 and 17. Firstly, the predictor generation branch 1600 may additionally output an auxiliary quantity that will be denoted as hidden memory or H. The hidden memory, H, may be used to output information about motion estimation. An updated predictor generation branch 1600 is shown in FIG. 16, in which \hat{F}_{T} is inputted into a hidden memory decoder 1612 to generate the hidden memory, H. For some embodiments, the hidden memory decoder 1612 uses the same architecture as the motion decoder of FIG. 11, except the last convolutional layer (“CONV 3” in FIG. 11) may output any channel dimension, not just three output channels. With such a design, the coordinates of the hidden memory, H, align with the coordinates of the current occupied block positions, B_{cur}.

The hidden memory, H, is a side output generated from the reconstructed transformation feature map, \hat{F}_{T}. The hidden memory may include additional information aside from motion about the relationship between and that may be “helpful” for compression. To use the hidden memory for conditional coding, H is concatenated with F_{pred}. See FIG. 17 for examples for encoding and decoding. To ensure that the same entity for hidden memory is used on both the encoder side and the decoder side, \hat{F}_{T} is used as an input to the hidden memory decoder.

For some embodiments, the hidden memory decoder may output additional motion information. The hidden memory is generated from the transformation feature map, which describes the motion/relationship between the current point cloud and the reference point cloud.

For some embodiments, FIG. 16 is a block diagram that adds a hidden memory decoder to the predictor generation branch shown in FIG. 7. See the description below for FIG. 17 regarding usage of the hidden memory signal, H. For some embodiments, hidden memory, H, has information which may be “useful” related to motion estimation.

FIG. 17 is a block diagram illustrating an example feature coding branch utilizing hidden memory according to some embodiments. The second “hidden memory” change is in the feature coding branch 1700. The hidden memory, H, may be used as an additional condition for both the conditional encoder 1704 and the conditional decoder 1714, as shown in FIG. 17. Since the coordinates of H are aligned with B_{cur}, which is also true for F_{pred} and F_{cur}, H may directly concatenated within the conditional encoder and decoder (FIGS. 15A and 15B, respectively). The hidden memory, H, of FIG. 17 may be used as an additional input condition to inform the conditional encoder/decoder of additional information related to the motion estimation that may benefit the compression. For some embodiments, the block-wise motion field, M, (in FIG. 10) also may be used as a condition. In this case, M, is also inputted to the conditional encoder for encoding, and to the conditional decoder for decoding.

In the feature coding branch 1700 of FIG. 17, the current point cloud frame, PC_{cur}, is inputted into a point cloud encoder 1702 to extract a feature map, F_{cur}. The feature map, F_{cur}, is further processed/aggregated by a conditional encoder 1704 using the predicted feature map, F_{pred}, to generate a conditional feature map, Fond. The conditional feature map may be aligned with block coordinates, B_{cur}, via a feature serialization block 1706. The (aligned) conditional feature map is quantized and then entropy encoded by an arithmetic encoder (AE) 1708 to generate the feature bitstream, BS_{feat}.

On the right side of FIG. 17, an arithmetic decoder (AD) 1710 decodes the bitstream, BS_{feat}, and a sparse tensor construction block 1712 incorporates the block coordinates, B_{cur}, to reconstruct the conditional feature map, denoted as \hat{F}_{cnd}. The reconstructed conditional feature map, \hat{F}_{cnd}, is inputted into the conditional decoder 1714. The conditional decoder 1714 takes the predicted feature map, F_{pred}, as a condition and outputs \hat{F}_{cur}, the reconstructed feature map of the current point cloud. The reconstructed conditional feature map, Écur, is inputted into a point cloud decoder 1716 to reconstruct the decoded point cloud, [symbol] _{cur}.

For some embodiments, in comparison with the feature coding branch shown in FIG. 8, FIG. 17 is a block diagram that adds the hidden memory as a condition for the conditional encoder and the conditional decoder. For some embodiments, FIG. 17 shows usage of the hidden memory signal, H. FIG. 16 shows generation of the hidden memory signal for some embodiments. For some embodiments, hidden memory, H, has information which may be “useful” related to motion estimation.

### Transformation Feature Downsampling

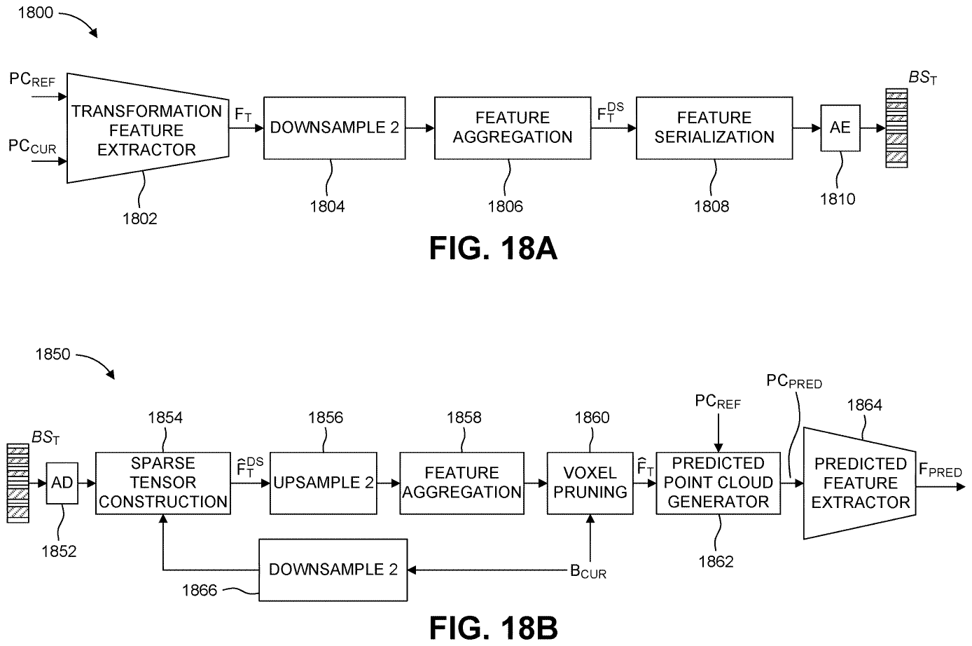

FIGS. 18A and 18B are block diagrams illustrating an example predictor generation branch with a transformation feature downsampling according to some embodiments. For some embodiments of the predictor generation branch 1800, 1850, PC_{REF} and PC_{CUR} are inputted into a transformation feature extractor 1802 to generate F_{T}. When the dynamics in a point cloud sequence are less complicated, the motion vectors of nearby blocks may be similar. To further exploit the spatial correlation among nearby motion transformation and achieve a higher compression ratio, some embodiments additionally downsample the motion transformation, F_{T}, before sending the motion transformation to the decoder. For some embodiments, only the predictor generation branch changes as shown in FIGS. 19A and 19B.

In FIG. 18A, F_{T} is downsampled 1804 by a factor of 2 (“Downsample 2” in FIG. 18A) and aggregated 1806 to generate

$${F}_{T}^{d s} .$$

The sparse tensor,

$${F}_{T}^{ds} ,$$

may be serialized 1808 and encoded 1810 as a tensor bitstream, BS_{T}. For some embodiments, the downsampling may be achieved with a pooling layer. For some embodiments, downsampling is achieved by a convolutional layer with a stride of two.

In FIG. 18B, the sparse tensor,

$${\hat{F}}_{T}^{d s} ,$$

is constructed, by a sparse tensor contraction block 1854, from the output of the arithmetic decoder 1852, the decoded bitstream, BS_{T}, and the 2× downsampled version of B_{cur}. For some embodiments,

$${\hat{F}}_{T}^{d s}$$

may be considered to be a quantized version of

$${F}_{T}^{d s} . {\hat{F}}_{T}^{d s}$$

is upsampled by a factor of two and aggregated by a feature aggregation block 1858. The purpose of downsampling 1866 by 2 in FIG. 18A and upsampling 1856 by 2 in FIG. 18B is to take advantage of the spatial correlation in the transformation feature. The output of the feature aggregation 1858 is inputted into a voxel pruning block to remove the voxels that are not within B_{cur}. The voxel pruning block 1860 generates a reconstructed motion transformation map, \hat{F}_{T}. For some embodiments, the downsampled transformation feature map

$$( {\hat{F}}_{T}^{d s} )$$

is first upsampled followed by feature aggregation, which leads to a 3D sparse tensor that may have redundant voxels out of the scope of B_{cur}. The pruning step is used (or is necessary for some embodiments) to refine the output of the feature aggregation. For some embodiments, the rest of the functionality of FIGS. 18A and 18B may be used to generate the predicted feature map, F_{pred}, stays the same as shown in FIG. 7. \hat{F}_{T} is inputted into the predicted point cloud generator 1862. The predicted point cloud, PC_{pred}, is inputted into a predicted feature extractor 1864 for extracting the predicted feature map, F_{pred}.

For some embodiments, the upsample block may be implemented by a nearest neighbor upsampling block. For some embodiments, the upsampling block may be implemented by a deconvolutional layer with a stride of two. Compare the predictor generation branch of FIG. 7 to the predictor generation branch shown in FIGS. 18A and 18B. FIG. 18A adds downsample by 2 and feature aggregation blocks to the predictor generation branch for some embodiments. FIG. 18B adds upsample by 2, feature aggregation, voxel pruning, and downsample by 2 blocks to the predictor generation branch for some embodiments. These additions are described above. As mentioned above, the pruning step is used (or is necessary for some embodiments) to refine the output of the feature aggregation.

### Intra Mode

FIG. 19 is a block diagram illustrating an example feature coding branch in intra mode according to some embodiments. This application discusses dynamic point cloud compression, which compresses a current frame based on a previously reconstructed frame. Some embodiments support an intra mode, which compresses the current frame independently. Under the intra mode, the predictor generation branch (which is shown in FIG. 7) is removed, and the feature coding branch 1900 is slightly changed, as shown in FIG. 19. Compared to the feature coding branch of FIG. 8, the condition F_{pred} is replaced with PC_{const} in FIG. 19. PC_{const} is a point cloud represented in sparse tensor format with all its features being a predefined constant, such as 1. In intra mode, the same fixed condition is used for conditional encoding and decoding. Regarding intra-mode, see the '087 application, which is incorporated herein by reference in its entirety and which discusses point-based and voxel-based representations for point cloud compression.

For some embodiments, PC_{const} may serve as a “dummy” or stand-in version of F_{pred} in which PC_{const} is known by both the encoder and decoder sides of the bitstream. If “intra mode” is used, then PC_{const} is used instead of F_{pred}. FIG. 19 shows an example of this scenario. The current point cloud, PC_{cur}, may be encoded/decoded independently without using a reference point cloud, PC_{ref}. Hence, this scenario is called “intra mode” (versus using a reference point cloud, which may be called “inter mode”). Under “intra mode,” the predictor generation branch is shut down. For some embodiments, the purpose for using PC_{const} is to re-use the same neural network architecture to handle both intra- and inter-coding.

In the feature coding branch 1900 of FIG. 19, the current point cloud frame, PC_{cur}, is inputted into a point cloud encoder 1902 to extract a feature map, F_{cur}. The feature map, F_{cur}, is further processed/aggregated by a conditional encoder 1904 using the predicted feature map, F_{pred}, to generate a conditional feature map, Fond. The conditional feature map may be aligned with block coordinates, B_{cur}, via a feature serialization block 1906. The (aligned) conditional feature map is quantized and then entropy encoded by an arithmetic encoder (AE) 1908 to generate the feature bitstream, BS_{feat}.

On the right side of FIG. 19, an arithmetic decoder (AD) 1910 decodes the bitstream, BS_{feat}, and a sparse tensor construction block 1912 incorporates the block coordinates, B_{cur}, to reconstruct the conditional feature map, denoted as \hat{F}_{cnd}. The reconstructed conditional feature map, \hat{F}_{cnd}, is inputted into the conditional decoder 1914. The conditional decoder 1914 takes the predicted feature map, F_{pred}, as a condition and outputs \hat{F}_{cur}, the reconstructed feature map of the current point cloud. The reconstructed conditional feature map, \hat{F}_{cur}, is inputted into a point cloud decoder 1916 to reconstruct the decoded point cloud, [symbol] _{cur}.

For some embodiments, in comparison with the feature coding branch shown in FIG. 8, FIG. 19 is a block diagram that uses PC_{const} as a condition for the conditional encoder 1904 and the conditional decoder 1914. To support intra coding mode, the predictor generation branch (which is shown in FIG. 7 for some embodiments) may be omitted and F_{pred} may not be generated for some embodiments. The feature coding branch shown in FIG. 8 is modified so that the conditional encoder and conditional decoder are conditioned on a constant, which may be a pre-determined point cloud feature set. As a result, the various blocks of the feature coding branch may remain the same in support of intra-frame point cloud compression; only the conditional data used as inputs to the conditional encoder and conditional decoder would change.

### Utilizing Point Cloud Attribute for Motion Estimation

When certain types of point clouds attributes, e.g., reflectance, and RGB color, are available, these attributes may be additionally utilized to improve the transformation feature extraction on the encoder side.

For some embodiments, if attributes are not available, under the point-based representation, the point cloud is a set of 3D points. Stated differently, if the point cloud attributes, e.g., reflectance, are available, then for each 3D point x=(x, y, z) in the point cloud, the 3D point is augmented as a 4D vector (x, r)=(x, y, z, r), in which r is the reflectance attribute of the LiDAR point cloud. A point cloud represented in sparse tensor format with the attributes may be denoted as an augmented point cloud. The augmented point cloud of the current point cloud frame is denoted as

$$P {C}_{cur}^{a u g} .$$

Similarly, the augmented point cloud of the current point cloud frame is denoted as

$$P {C}_{cur}^{a u g} .$$

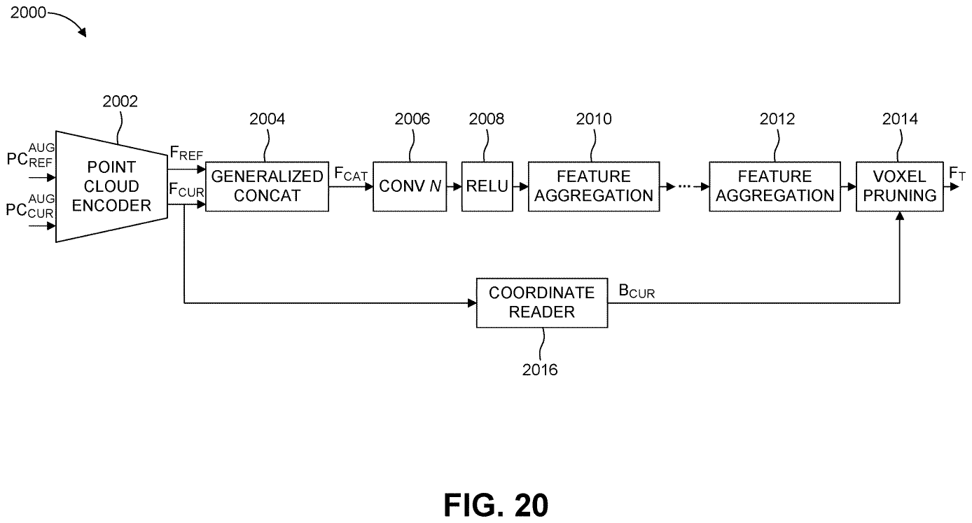

FIG. 20 is a block diagram illustrating an example transformation feature extractor using augmented point clouds according to some embodiments. For some embodiments, if both

$$P {C}_{cur}^{a u g} and {PC}_{r e f}^{a u g}$$

are available on the encoder

$$, {PC}_{c u r}^{a u g} and {PC}_{ref}^{a u g}$$

may be utilized to extract the transformation feature, F_{T}, as shown in FIG. 20, instead of using PC_{cur} and PC_{ref} (geometry only) as shown in FIG. 9. A point in a point cloud may have RGB color or reflectance (attribute) information in addition to a 3D position (geometry). A neural network may be designed to process a subset or all of these properties for some embodiments. The term “geometry only” means only 3D positions and does not include any attribute information for some embodiments. With both geometry and attributes being available, the transformation feature, F_{T}, may be more accurate, which may improve the motion field, M, and the predicted point cloud, PC_{pred}. As such, better compression performance may be achieved.

For some embodiments, FIG. 20 is a block diagram of the transformation feature extractor 2000 that fits within the predictor generation branch shown in FIG. 7. FIG. 20 shows how point cloud attributes, e.g., R, G, B color or reflectance values for each point, may be used to improve estimation of the motion transformation map, F_{T}. The augmented version (“aug”) of the point cloud inputs may include the attribute information. Comparing FIGS. 9 and 20,

$$P {C}_{cur}^{a u g} and {PC}_{r e f}^{a u g}$$

as inputs in the point cloud encoder 2002 in FIG. 20 instead of PC_{cur} and PC_{ref}, which as shown in FIG. 9. Furthermore, FIG. 9 uses only geometry for the input point clouds, while FIG. 20 uses geometry plus the augmented information for the input point clouds for some embodiments.

The two extracted feature maps, F_{cur} and F_{ref}, are concatenated together by a generalized concatenation block 2004, which outputs a combined feature map, F_{cmb}. The combined feature, F_{cmb}, is inputted into a 3D sparse convolution layer 2006, which converts the feature dimension to N, followed by a ReLU activation function 2008. The output is passed to a series of feature aggregation blocks 2010, 2012. The voxels that do not belong to B_{cur} are removed by a voxel pruning block 2014. The block coordinates, B_{cur}, may be generated by a coordinate reader 2016. The output of the voxel pruning block is a transformation feature map, F_{T}.

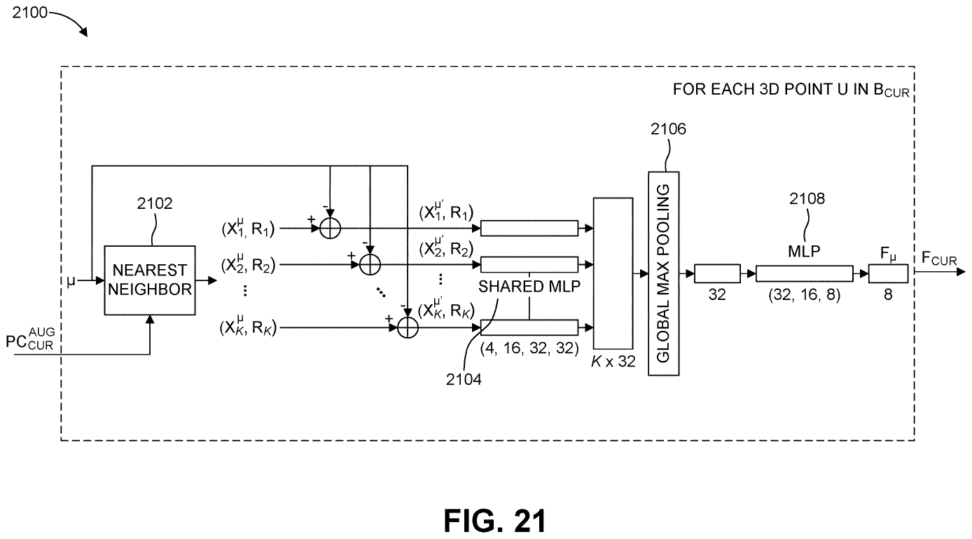

FIG. 21 is a process diagram illustrating an example point cloud encoder according to some embodiments. If attribute information is available, the point cloud encoder 2100 is slightly changed. FIG. 21 illustrates a feature extraction of an augmented current point cloud

$${PC}_{cur}^{aug} .$$

Compared to FIG. 13, FIG. 21 shows the reflectance information appended with the 3D coordinates. The nearest neighbor search 2102 looks for the points in

$$P {C}_{c u r}^{a u g}$$

that are closest to u in the 3D space, regardless of the attribute information r. Moreover, if subtracting u from the nearest neighbors, only the 3D coordinates of the nearest neighbors are subtracted, and the attribute r remains unchanged. For example,

$$( {x}_{1}^{u} , {r}_{1} )$$

becomes

$$( {x}_{1}^{{u}^{′}} , {r}_{1} )$$

for

$${x}_{1}^{{u}^{′}} = {x}_{1}^{u} - u .$$

Moreover, the shared MLP now accepts 4D vectors as its input. Therefore, the first layer of the shared MLP 2104 has a dimension of 4 instead of 3.

The shared MLP 2104 output a set of points, which are inputted into a global max pooling operator 2106. The global max operator 2106 extracts a global feature vector. This global feature vector is further processed by another set of MLP layers 2108, leading to the output feature vector fᵤ. The set of feature vectors fᵤ for all the points u in B_{cur} form the output feature map F_{cur}.

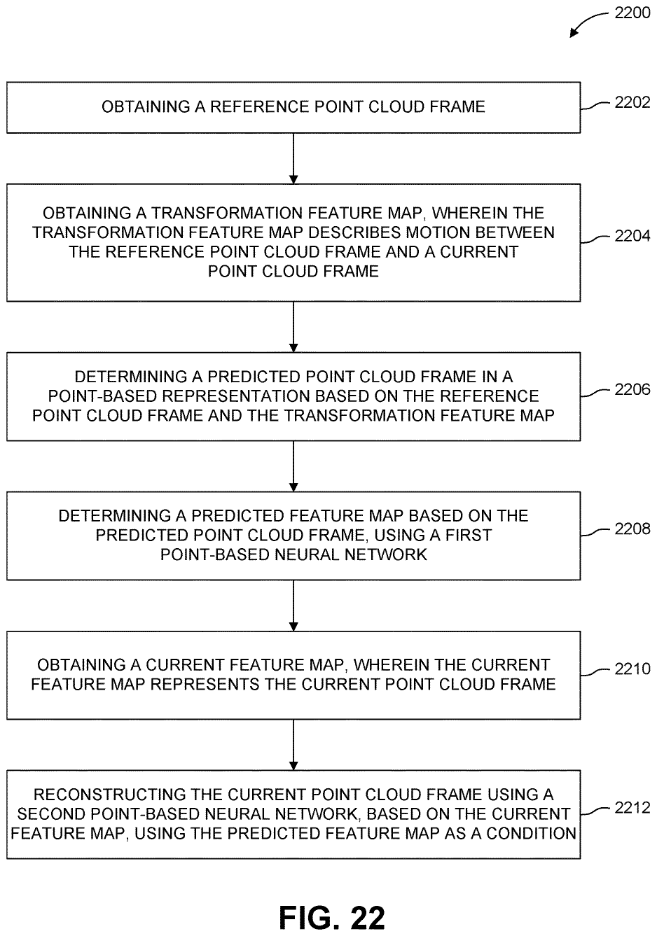

FIG. 22 is a flowchart illustrating an example point cloud decoder process according to some embodiments. For some embodiments, an example process 2200 may include obtaining 2202 a reference point cloud frame. For some embodiments, the example process 2200 may further include obtaining 2204 a transformation feature map, wherein the transformation feature map describes motion between the reference point cloud frame and a current point cloud frame. For some embodiments, the example process 2200 may further include determining 2206 a predicted point cloud frame in a point-based representation based on the reference point cloud frame and the transformation feature map. For some embodiments, the example process 2200 may further include determining 2208 a predicted feature map based on the predicted point cloud frame, using a first point-based neural network. For some embodiments, the example process 2200 may further include obtaining 2210 a current feature map, wherein the current feature map represents the current point cloud frame. For some embodiments, the example process 2200 may further include reconstructing 2212 the current point cloud frame using a second point-based neural network, based on the current feature map, using the predicted feature map as a condition.

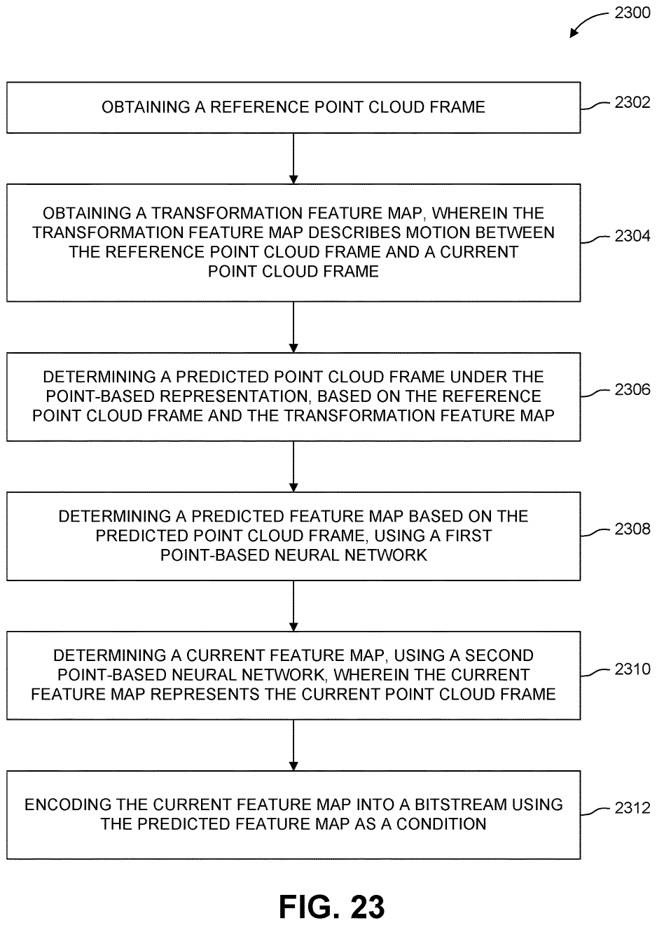

FIG. 23 is a flowchart illustrating an example point cloud encoder process according to some embodiments. For some embodiments, an example process 2300 may include obtaining 2302 a reference point cloud frame. For some embodiments, the example process 2300 may further include obtaining 2304 a transformation feature map. For some embodiments of the example process 2300, the transformation feature map describes motion between the reference point cloud frame and a current point cloud frame. For some embodiments, the example process 2300 may further include determining 2306 a predicted point cloud frame under the point-based representation, based on the reference point cloud frame and the transformation feature map. For some embodiments, the example process 2300 may further include determining 2308 a predicted feature map based on the predicted point cloud frame, using a first point-based neural network. For some embodiments, the example process 2300 may further include determining 2310 a current feature map, using a second point-based neural network. For some embodiments of the example process 2300, the current feature map represents the current point cloud frame. For some embodiments, the example process 2300 may further include encoding 2312 the current feature map into a bitstream using the predicted feature map as a condition.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a reference point cloud frame; obtaining a transformation feature map, wherein the transformation feature map describes motion between the reference point cloud frame and a current point cloud frame; determining a predicted point cloud frame in a point-based representation based on the reference point cloud frame and the transformation feature map; determining a predicted feature map based on the predicted point cloud frame, using a first point-based neural network; obtaining a current feature map, wherein the current feature map represents the current point cloud frame; and reconstructing the current point cloud frame using a second point-based neural network, based on the current feature map, using the predicted feature map as a condition.

For some embodiments of the first example method, the first point-based neural network includes a point-based encoder neural network, and the second point-based neural network includes a point-based decoder neural network.

For some embodiments of the first example method, the reference point cloud frame was decoded from an earlier point cloud frame prior to the current point cloud frame.

For some embodiments of the first example method, determining the predicted point cloud frame includes: decoding a motion field based on the transformation feature map; and generating the predicted point cloud frame based on the reference point cloud frame and the decoded motion field.

For some embodiments of the first example method, decoding the motion field includes: performing feature aggregations iteratively on the transformation feature map to derive a feature aggregation iterative output; and performing a convolution on the feature aggregation iterative output to generate the motion field.

Some embodiments of the first example method may further include performing at least one upsampling on the feature aggregation output prior to performing the convolution.

For some embodiments of the first example method, generating the predicted point cloud frame includes: shifting occupied blocks in the reference point cloud frame based on the motion field; searching the reference point cloud frame to obtain nearest neighbors, based on the shifted occupied block coordinates; and creating the predicted point cloud using the obtained nearest neighbors.

For some embodiments of the first example method, reconstructing the current point cloud frame includes: performing a conditional decode to generate the current feature map; and performing a point cloud decode using the current feature map to generate the current point cloud frame.

For some embodiments of the first example method, performing the conditional decode includes: performing a concatenation on a conditional feature map based on the predicted feature map; and performing feature aggregations iteratively to generate the current feature map.

For some embodiments of the first example method, the concatenation is further based on an additional condition.

For some embodiments of the first example method, the additional condition includes a hidden memory decoder output.

Some embodiments of the first example method may further include generating the hidden memory decoder output based on the transformation feature map.

Some embodiments of the first example method may further include upsampling the transformation feature map.

For some embodiments of the first example method, reconstructing the current point cloud frame uses a constant point cloud as a condition instead of the predicted feature map.

A first example apparatus in accordance with some embodiments may include: a processor; and a non-transitory computer-readable medium storing instructions operative, when executed by the processor, to cause the apparatus to: obtain a reference point cloud frame; obtain a transformation feature map, wherein the transformation feature map describes motion between the reference point cloud frame and a current point cloud frame; determine a predicted point cloud frame in a point-based representation based on the reference point cloud frame and the transformation feature map; determine a predicted feature map based on the predicted point cloud frame, using a first point-based neural network; obtain a current feature map, wherein the current feature map represents the current point cloud frame; and reconstruct the current point cloud frame using a second point-based neural network, based on the current feature map, using the predicted feature map as a condition.

For some embodiments of the first example apparatus, the first point-based neural network includes a point-based encoder neural network, and the second point-based neural network includes a point-based decoder neural network.

A second method in accordance with some embodiments may include: obtaining a reference point cloud frame; obtaining a first transformation feature map, wherein the first transformation feature map describes motion between the reference point cloud frame and a current point cloud frame; encoding the first transformation feature map; reconstructing a second transformation feature map from the first transformation feature map; determining a predicted point cloud frame under the point-based representation, based on the reference point cloud frame and the second transformation feature map; determining a predicted feature map based on the predicted point cloud frame, using a first point-based neural network; determining a current feature map, using a second point-based neural network, wherein the current feature map represents the current point cloud frame; and encoding the current feature map into a bitstream using the predicted feature map as a condition.

For some embodiments of the second example method, the first point-based neural network includes a first point-based encoder neural network, and wherein the second point-based neural network includes a second point-based encoder neural network.

Some embodiments of the second example method may further include sending the first bitstream to a decoder.

For some embodiments of the second example method, the reference point cloud frame was encoded previously.

For some embodiments of the second example method, determining the predicted point cloud frame includes: decoding a motion field based on the second transformation feature map; and generating the predicted point cloud frame based on the reference point cloud frame and the decoded motion field.

For some embodiments of the second example method, decoding the motion field includes: performing feature aggregations iteratively on the second transformation feature map to derive a feature aggregation iterative output; and performing a convolution on the feature aggregation iterative output to generate the motion field.

Some embodiments of the second example method may further include performing at least one upsampling on the feature aggregation output prior to performing the convolution.

For some embodiments of the second example method, generating the predicted point cloud frame includes: shifting occupied blocks in the reference point cloud frame based on the motion field; searching the reference point cloud frame to obtain nearest neighbors, based on the shifted occupied block coordinates; and creating the predicted point cloud using the obtained nearest neighbors.

For some embodiments of the second example method, encoding the current point cloud frame includes: performing a point cloud encode using the current point cloud frame to generate the current feature map; performing a conditional encode to generate a conditional feature map; and generating the second bitstream based on the conditional feature map.

For some embodiments of the second example method, performing the conditional encode includes: performing a concatenation on the current feature map based on the predicted feature map; and performing feature aggregations iteratively to generate a conditional feature map.

For some embodiments of the second example method, the concatenation is further based on an additional condition.

For some embodiments of the second example method, the additional condition is a hidden memory decoder output.

Some embodiments of the second example method may further include generating the hidden memory decoder output based on the second transformation feature map.

Some embodiments of the second example method may further include downsampling the second transformation feature map.

For some embodiments of the second example method, encoding the current feature map into the second bitstream uses a constant point cloud as a condition instead of the predicted feature map.

For some embodiments of the second example method, obtaining the first transformation feature map includes extracting one or more motion differences between the reference point cloud frame and the current point cloud frame to generate the first transformation feature map.

For some embodiments of the second example method, obtaining the first transformation feature map includes generating the first transformation feature map using the reference point cloud frame and the current point cloud frame.

For some embodiments of the second example method, obtaining the transformation feature map includes using an augmented version of the reference point cloud frame and an augmented version of the current point cloud frame.

A second apparatus in accordance with some embodiments may include: a processor; and a non-transitory computer-readable medium storing instructions operative, when executed by the processor, to cause the apparatus to: obtain a reference point cloud frame; obtain a first transformation feature map, wherein the first transformation feature map describes motion between the reference point cloud frame and a current point cloud frame; encode the first transformation feature map; reconstruct a second transformation feature map from the first transformation feature map; determine a predicted point cloud frame under the point-based representation, based on the reference point cloud frame and the second transformation feature map; determine a predicted feature map based on the predicted point cloud frame, using a first point-based neural network; determine a current feature map, using a second point-based neural network, wherein the current feature map represents the current point cloud frame; and encode the current feature map into a bitstream using the predicted feature map as a condition.

For some embodiments of the second example apparatus, the first point-based neural network includes a first point-based encoder neural network, and wherein the second point-based neural network includes a second point-based encoder neural network.

A third apparatus in accordance with some embodiments may include a processor configured to perform any of the methods listed above.

For some embodiments of the third example apparatus, the apparatus includes a decoding device.

A fourth apparatus in accordance with some embodiments may include: a processor configured to perform any of the methods listed above.

For some embodiments of the fourth example apparatus, the apparatus includes an encoding device.

For some embodiments of the second example method, generating the first transformation feature map further uses one or more point cloud attributes.

For some embodiments of the second example method, the point cloud attributes include color or reflectance attributes associated with at least one point of the point cloud.

An example method in accordance with some embodiments may include: obtaining a reference point cloud frame; obtaining a transformation feature map, wherein the transformation feature map describes motion between the reference point cloud frame and a current point cloud frame; determining a predicted point cloud frame in a point-based representation based on the reference point cloud frame and the transformation feature map; determining a predicted feature map based on the predicted point cloud frame, using a first point-based neural network; obtaining a current feature map, wherein the current feature map represents the current point cloud frame; and reconstructing the current point cloud frame using a second point-based neural network, based on the current feature map, using the predicted feature map as a condition.

For some embodiments of an example method, the first point-based neural network may include a point-based encoder neural network, and the second point-based neural network may include a point-based decoder neural network.

For some embodiments of an example method, the reference point cloud frame was decoded from an earlier point cloud frame prior to the current point cloud frame.

For some embodiments of an example method, determining the predicted point cloud frame may include: decoding a motion field based on the transformation feature map; and generating the predicted point cloud frame based on the reference point cloud frame and the decoded motion field.

For some embodiments of an example method, decoding the motion field may include: performing feature aggregations iteratively on the transformation feature map to derive a feature aggregation iterative output; and performing a convolution on the feature aggregation iterative output to generate the motion field.

Some embodiments of an example method further include performing at least one upsampling on the feature aggregation output prior to performing the convolution.

For some embodiments of an example method, generating the predicted point cloud frame may include: shifting occupied blocks in the reference point cloud frame based on the motion field; searching the reference point cloud frame to obtain nearest neighbors, based on the shifted occupied block coordinates; and creating the predicted point cloud using the obtained nearest neighbors.

For some embodiments of an example method, reconstructing the current point cloud frame may include: performing a conditional decode to generate the current feature map; and performing a point cloud decode using the current feature map to generate the current point cloud frame.

For some embodiments of an example method, performing the conditional decode may include: performing a concatenation on a conditional feature map based on the predicted feature map; and performing feature aggregations iteratively to generate the current feature map.

For some embodiments of an example method, the concatenation is further based on an additional condition.

For some embodiments of an example method, the additional condition may include a hidden memory decoder output.

Some embodiments of an example method further include generating the hidden memory decoder output based on the transformation feature map.

Some embodiments of an example method further include upsampling the transformation feature map.

For some embodiments of an example method, reconstructing the current point cloud frame uses a constant point cloud as a condition instead of the predicted feature map.

An example apparatus in accordance with some embodiments may include: a processor; and a non-transitory computer-readable medium storing instructions operative, when executed by the processor, to cause the apparatus to: obtain a reference point cloud frame; obtain a transformation feature map, wherein the transformation feature map describes motion between the reference point cloud frame and a current point cloud frame; determine a predicted point cloud frame in a point-based representation based on the reference point cloud frame and the transformation feature map; determine a predicted feature map based on the predicted point cloud frame, using a first point-based neural network; obtain a current feature map, wherein the current feature map represents the current point cloud frame; and reconstruct the current point cloud frame using a second point-based neural network, based on the current feature map, using the predicted feature map as a condition.

For some embodiments of an example apparatus, the first point-based neural network may include a point-based encoder neural network, and the second point-based neural network may include a point-based decoder neural network.

A further example method in accordance with some embodiments may include: obtaining a reference point cloud frame; obtaining a transformation feature map, wherein the transformation feature map describes motion between the reference point cloud frame and a current point cloud frame; determining a predicted point cloud frame under the point-based representation, based on the reference point cloud frame and the transformation feature map; determining a predicted feature map based on the predicted point cloud frame, using a first point-based neural network; determining a current feature map, using a second point-based neural network, wherein the current feature map represents the current point cloud frame; and encoding the current feature map into a bitstream using the predicted feature map as a condition.

For some embodiments of a further example method, the first point-based neural network may include a first point-based encoder neural network, and wherein the second point-based neural network may include a second point-based encoder neural network.

Some embodiments of a further example method further include sending the first bitstream to a decoder.

For some embodiments of a further example method, the reference point cloud frame was encoded previously.

For some embodiments of a further example method, determining the predicted point cloud frame may include: decoding a motion field based on the second transformation feature map; and generating the predicted point cloud frame based on the reference point cloud frame and the decoded motion field.

For some embodiments of a further example method, decoding the motion field may include: performing feature aggregations iteratively on the second transformation feature map to derive a feature aggregation iterative output; and performing a convolution on the feature aggregation iterative output to generate the motion field.

Some embodiments of a further example method further include performing at least one upsampling on the feature aggregation output prior to performing the convolution.

For some embodiments of a further example method, generating the predicted point cloud frame may include: shifting occupied blocks in the reference point cloud frame based on the motion field; searching the reference point cloud frame to obtain nearest neighbors, based on the shifted occupied block coordinates; and creating the predicted point cloud using the obtained nearest neighbors.

For some embodiments of a further example method, encoding the current point cloud frame may include: performing a point cloud encode using the current point cloud frame to generate the current feature map; performing a conditional encode to generate a conditional feature map; and generating the second bitstream based on the conditional feature map.

For some embodiments of a further example method, performing the conditional encode may include: performing a concatenation on the current feature map based on the predicted feature map; and performing feature aggregations iteratively to generate a conditional feature map.

For some embodiments of a further example method, the concatenation is further based on an additional condition.

For some embodiments of a further example method, the additional condition is a hidden memory decoder output.

Some embodiments of a further example method further include generating the hidden memory decoder output based on the second transformation feature map.

Some embodiments of a further example method further include upsampling the second transformation feature map.

For some embodiments of a further example method, encoding the current feature map into the second bitstream uses a constant point cloud as a condition instead of the predicted feature map.

For some embodiments of a further example method, obtaining the first transformation feature map may include extracting one or more motion differences between the reference point cloud frame and the current point cloud frame to generate the first transformation feature map.

For some embodiments of a further example method, obtaining the first transformation feature map may include generating the first transformation feature map using the reference point cloud frame and the current point cloud frame.

For some embodiments of a further example method, obtaining the transformation feature map may include using an augmented version of the reference point cloud frame and an augmented version of the current point cloud frame.

A further example method in accordance with some embodiments may include: a processor; and a non-transitory computer-readable medium storing instructions operative, when executed by the processor, to cause the apparatus to: obtain a reference point cloud frame; obtain a transformation feature map, wherein the transformation feature map describes motion between the reference point cloud frame and a current point cloud frame; determine a predicted point cloud frame under the point-based representation, based on the reference point cloud frame and the transformation feature map; determine a predicted feature map based on the predicted point cloud frame, using a first point-based neural network; determine a current feature map, using a second point-based neural network, wherein the current feature map represents the current point cloud frame; and encode the current feature map into a bitstream using the predicted feature map as a condition.

For some embodiments of a further example apparatus, the first point-based neural network may include a first point-based encoder neural network, and wherein the second point-based neural network may include a second point-based encoder neural network.

A yet further example apparatus in accordance with some embodiments may include: a processor configured to perform any of the methods listed above.

For some embodiments of a yet further example apparatus, the apparatus may include a decoding device.

Another further example apparatus in accordance with some embodiments may include a processor configured to perform any of the methods listed above.

For some embodiments of another further example apparatus, wherein the apparatus may include an encoding device.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present disclosure, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

The terms HDR (high dynamic range) and SDR (standard dynamic range) often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining a reference point cloud frame;
obtaining a transformation feature map,
wherein the transformation feature map describes motion between the reference point cloud frame and a current point cloud frame;
determining a predicted point cloud frame in a point-based representation based on the reference point cloud frame and the transformation feature map;
determining a predicted feature map based on the predicted point cloud frame, using a first point-based neural network;
obtaining a current feature map,
wherein the current feature map represents the current point cloud frame; and
reconstructing the current point cloud frame using a second point-based neural network, based on the current feature map, using the predicted feature map as a condition.

2. The method of claim 1,
wherein the first point-based neural network comprises a point-based encoder neural network, and
wherein the second point-based neural network comprises a point-based decoder neural network.

3. The method of claim 1, wherein the reference point cloud frame was decoded from an earlier point cloud frame prior to the current point cloud frame.

4. The method of claim 1, wherein determining the predicted point cloud frame comprises:
decoding a motion field based on the transformation feature map; and
generating the predicted point cloud frame based on the reference point cloud frame and the decoded motion field.

5. The method of claim 4, wherein decoding the motion field comprises:
performing feature aggregations iteratively on the transformation feature map to derive a feature aggregation iterative output; and
performing a convolution on the feature aggregation iterative output to generate the motion field.

6. The method of claim 5, further comprising performing at least one upsampling on the feature aggregation output prior to performing the convolution.

7. The method of claim 4, wherein generating the predicted point cloud frame comprises:
shifting occupied blocks in the reference point cloud frame based on the motion field;
searching the reference point cloud frame to obtain nearest neighbors, based on the shifted occupied block coordinates; and
creating the predicted point cloud using the obtained nearest neighbors.

8. The method of claim 1, wherein reconstructing the current point cloud frame comprises:
performing a conditional decode to generate the current feature map; and
performing a point cloud decode using the current feature map to generate the current point cloud frame.

9. The method of claim 8, wherein performing the conditional decode comprises:
performing a concatenation on a conditional feature map based on the predicted feature map; and
performing feature aggregations iteratively to generate the current feature map.

10. The method of claim 9, wherein the concatenation is further based on an additional condition.

11. The method of claim 10, wherein the additional condition comprises a hidden memory decoder output.

12. The method of claim 11, further comprising generating the hidden memory decoder output based on the transformation feature map.

13. The method of claim 1, further comprising upsampling the transformation feature map.

14. The method of claim 1, wherein reconstructing the current point cloud frame uses a constant point cloud as a condition instead of the predicted feature map.

15. An apparatus comprising:
a processor; and
a non-transitory computer-readable medium storing instructions operative, when executed by the processor, to cause the apparatus to:
obtain a reference point cloud frame;
obtain a transformation feature map,
wherein the transformation feature map describes motion between the reference point cloud frame and a current point cloud frame;
determine a predicted point cloud frame in a point-based representation based on the reference point cloud frame and the transformation feature map;
determine a predicted feature map based on the predicted point cloud frame, using a first point-based neural network;
obtain a current feature map,
wherein the current feature map represents the current point cloud frame; and
reconstruct the current point cloud frame using a second point-based neural network, based on the current feature map, using the predicted feature map as a condition.

16. (canceled)

17. A method comprising:
obtaining a reference point cloud frame;
obtaining a first transformation feature map,
wherein the first transformation feature map describes motion between the reference point cloud frame and a current point cloud frame;
encoding the first transformation feature map;
reconstructing a second transformation feature map from the first transformation feature map;
determining a predicted point cloud frame under a point-based representation, based on the reference point cloud frame and the second transformation feature map;
determining a predicted feature map based on the predicted point cloud frame, using a first point-based neural network;
determining a current feature map, using a second point-based neural network,
wherein the current feature map represents the current point cloud frame; and
encoding the current feature map into a bitstream using the predicted feature map as a condition.

18. The method of claim 17, wherein the first point-based neural network comprises a first point-based encoder neural network, and wherein the second point-based neural network comprises a second point-based encoder neural network.

19-23. (canceled)

24. The method of claim 17, wherein generating the predicted point cloud frame comprises:
shifting occupied blocks in the reference point cloud frame based on the motion field;
searching the reference point cloud frame to obtain nearest neighbors, based on the shifted occupied block coordinates; and
creating the predicted point cloud using the obtained nearest neighbors.

25-31. (canceled)

32. The method of claim 17, wherein obtaining the first transformation feature map comprises extracting one or more motion differences between the reference point cloud frame and the current point cloud frame to generate the first transformation feature map.

33. (canceled)

34. The method of claim 17, wherein obtaining the transformation feature map comprises using an augmented version of the reference point cloud frame and an augmented version of the current point cloud frame.

35-42. (canceled)
